(19) United States
(12) Patent Application Publication
(10) Pub. No.: US 2021/0075265 A1
(43) Pub. Date: Mar. 11, 2021

(54) POWER TRANSMITTING MODULE, POWER RECEIVING MODULE, POWER TRANSMITTING DEVICE, POWER RECEIVING DEVICE, AND WIRELESS POWER TRANSMISSION SYSTEM

(71) Applicant: Panasonic Intellectual Property Management Co., Ltd., Osaka (JP)

(72) Inventor: Hiroshi KANNO, Osaka (JP)

(21) Appl. No.: 17/041,496

(22) PCT Filed: Mar. 28, 2019
(86) PCT No.: PCT/JP2019/013789

§ 371 Date: Sep. 25, 2020

(30) Foreign Application Priority Data
Mar. 28, 2018 (JP) 2018-062349

(51) Int. Cl. H02J 50/12; H02J 50/00; H02J 50/05

(52) U.S. Cl. CPC H02J 50/12; H02J 2310/40; H02J 50/05; H02J 50/005

(57) ABSTRACT

A power transmitting module includes a first electrode and a second electrode, which are a power transmitting electrode pair, and a matching circuit to be connected to the first and second electrodes. The matching circuit includes a first inductor connected to the first electrode, a second inductor connected to the second electrode, and a first capacitor. The first capacitor is connected between a wire between the first electrode and the first inductor and a wire between the second electrode and the second inductor. The power transmitting module further includes a second capacitor connected to the first inductor and a third inductor. The third inductor is connected between a wire between the first inductor and the second capacitor and a wire connected to the second inductor.

### TECHNICAL FIELD

The present disclosure relates to a power transmitting module, a power receiving module, a power transmitting device, a power receiving device and a wireless power transmission system.

### BACKGROUND ART

In recent years, wireless power transmission techniques have been developed for transmitting electric power wirelessly, i.e., in a contactless manner, to a device with mobility such as a mobile telephone or an electric car. The wireless power transmission techniques include those of the electromagnetic induction method and those of the electric field coupling method. In a wireless power transmission system of the electric field coupling method, AC power is transmitted wirelessly from a pair of power transmitting electrodes to a pair of power receiving electrodes, with the pair of power transmitting electrodes and the pair of power receiving electrodes opposing each other. Patent Document No. 1 and Patent Document No. 2 disclose an example of such a wireless power transmission system of the electric field coupling method.

### CITATION LIST

### Patent Literature

Patent Document No. 1: International Publication WO2013/140665 pamphlet

Patent Document No. 2: Japanese Laid-Open Patent Publication No. 2010-193692

### SUMMARY OF INVENTION

### Technical Problem

The present disclosure provides a technique for improving the power transmission characteristic of a wireless power transmission system of an electric field coupling method.

### Solution to Problem

A power transmitting module according to one aspect of the present disclosure is used in a power transmitting device in a wireless power transmission system of an electric field coupling method. The power transmitting module includes: a first electrode and a second electrode, which are a power transmitting electrode pair; and a matching circuit to be connected between a power conversion circuit and the first and second electrodes in the power transmitting device. The power conversion circuit includes a first terminal and a second terminal and converts electric power output from a power source into AC power for transmission to output the converted power from the first and second terminals. The matching circuit includes: a first inductor connected to the first electrode; a second inductor connected to the second electrode; a first capacitor connected between a wire between the first electrode and the first inductor and a wire between the second electrode and the second inductor; a second capacitor connected to the first inductor; and a third inductor connected between a wire between the first inductor and the second capacitor and a wire connected to the second inductor. On an opposite side from the first electrode, the second capacitor is to be directly or indirectly connected to the first terminal of the power conversion circuit. On an opposite side from the second electrode, the second inductor is to be directly or indirectly connected to the second terminal of the power conversion circuit.

A power transmitting module according to another aspect of the present disclosure is used in a power transmitting device in a wireless power transmission system of an electric field coupling method. The power transmitting module includes: a first electrode and a second electrode, which are a power transmitting electrode pair; and a matching circuit to be connected between a power conversion circuit and the first and second electrodes in the power transmitting device. The power conversion circuit includes a first terminal and a second terminal and converts electric power output from a power source into AC power for transmission to output the converted power from the first and second terminals. The matching circuit includes: a first inductor connected to the first electrode; a second inductor connected to the second electrode; a first capacitor connected between a wire between the first electrode and the first inductor and a wire between the second electrode and the second inductor; a third inductor connected to the first inductor; and a second capacitor connected between a wire between the first inductor and the third inductor and a wire connected to the second inductor. On an opposite side from the first electrode, the third inductor is to be directly or indirectly connected to the first terminal of the power conversion circuit. On an opposite side from the second electrode, the second inductor is to be directly or indirectly connected to the second terminal of the power conversion circuit.

A power receiving module according to another aspect of the present disclosure is used in a power receiving device in a wireless power transmission system of an electric field coupling method. The power receiving module includes: a first electrode and a second electrode, which are a power receiving electrode pair; and a matching circuit to be connected between a power conversion circuit and the first and second electrodes in the power receiving device. The power conversion circuit includes a first terminal and a second terminal and converts AC power input to the first and second terminals into another form of electric power that is used by a load to output the converted power. The matching circuit includes: a first inductor connected to the first electrode; a second inductor connected to the second electrode; a first capacitor connected between a wire between the first electrode and the first inductor and a wire between the second electrode and the second inductor; a third inductor connected to the first inductor; and a second capacitor connected between a wire between the first inductor and the third inductor and a wire connected to the second inductor. On an opposite side from the first electrode, the third inductor is to be directly or indirectly connected the first terminal of the power conversion circuit. On an opposite side from the second electrode, the second inductor is to be directly or indirectly connected to the second terminal of the power conversion circuit.

A power receiving module according to another aspect of the present disclosure is a power receiving module used in a power receiving device in a wireless power transmission system of an electric field coupling method, the power receiving module including: a first electrode and a second electrode, which are a power receiving electrode pair; and a matching circuit to be connected between a power conversion circuit and the first and second electrodes in the power receiving device. The power conversion circuit includes a first terminal and a second terminal and converts AC power input to the first and second terminals into another form of electric power that is used by a load to output the converted power. The matching circuit includes: a first inductor connected to the first electrode; a second inductor connected to the second electrode; a first capacitor connected between a wire between the first electrode and the first inductor and a wire between the second electrode and the second inductor; a second capacitor connected to the first inductor; and a third inductor connected between a wire between the first inductor and the second capacitor and a wire connected to the second inductor. On an opposite side from the first electrode, the second capacitor is to be directly or indirectly connected to the first terminal of the power conversion circuit. On an opposite side from the second electrode, the second inductor is to be directly or indirectly connected to the second terminal or the power conversion circuit.

The general and specific aspects of the present disclosure may be implemented using a device, a system, a method, an integrated circuit, a computer program or a storage medium, or any combination of systems, devices, methods, integrated circuits, computer programs and storage media.

### Advantageous Effects of Invention

The technique of the present disclosure improves the power transmission characteristic of a wireless power transmission system of the electric field coupling method.

### BRIEF DESCRIPTION OF DRAWINGS

FIG. 1 is a diagram schematically showing an example of a wireless power transmission system of the electric field coupling method.

FIG. 2 is a diagram showing a general configuration of the wireless power transmission system shown in FIG. 1.

FIG. 3 is a diagram showing a system configuration according to a first comparative example.

FIG. 4 is a diagram showing a system configuration according to a second comparative example.

FIG. 5 is a schematic diagram of an electrode unit according to an exemplary embodiment of the present disclosure.

FIG. 6A is a diagram showing a first configuration example of a matching circuit.

FIG. 6B a diagram showing a second configuration example of a matching circuit.

FIG. 6C is a diagram showing a third configuration example of a matching circuit.

FIG. 6D is a diagram showing a fourth configuration example of a matching circuit.

FIG. 7 is a diagram showing a configuration of a wireless power transmission system according to an exemplary embodiment of the present disclosure.

FIG. 8 is a diagram schematically showing a configuration example of two inductors.

FIG. 9 is a diagram schematically showing a configuration example of a power conversion circuit of a power transmitting device.

FIG. 10 is a diagram schematically showing a configuration example of a power conversion circuit of a power receiving device.

FIG. 11A is a graph showing the dependence of the transmission characteristic of the configuration shown in FIG. 4 on the electrode-to-electrode gap.

FIG. 11B is a graph showing the dependence of the transmission characteristic of the configuration shown in FIG. 7 on the electrode-to-electrode gap.

FIG. 11C is a graph showing the dependence of the output voltage of the power receiving device of each of the configurations shown in FIG. 4 and FIG. 7 on the electrode-to-electrode gap.

FIG. 12A is a graph showing the dependence of the voltage between power transmitting electrodes on the electrode-to-electrode capacitance.

FIG. 12B is a graph showing the dependence of the voltage between power receiving electrodes on the electrode-to-electrode capacitance.

FIG. 13A is a diagram showing a first variation of a wireless power transmission system.

FIG. 13B is a diagram showing a second variation of a wireless power transmission system.

FIG. 13C is a diagram showing a third variation of a wireless power transmission system.

FIG. 13D is a diagram showing a fourth variation of a wireless power transmission system.

FIG. 14A is a diagram showing a variation of the matching circuit shown in FIG. 6A.

FIG. 14B is a diagram showing a variation of the matching circuit shown in FIG. 6B.

FIG. 14C is a diagram showing a variation of the matching circuit shown in FIG. 6C.

FIG. 14D is a diagram showing a variation of the matching circuit shown in FIG. 6D.

FIG. 15 is a diagram showing advantageous effects of the matching circuits shown in FIG. 14A to FIG. 14D.

FIG. 16 is a diagram showing a variation of a configuration of a wireless power transmission system according to an exemplary embodiment of the present disclosure.

### DESCRIPTION OF EMBODIMENTS

(Findings Forming Basis for Present Disclosure)

Findings forming the basis for the present disclosure will be described before describing embodiments of the present disclosure.

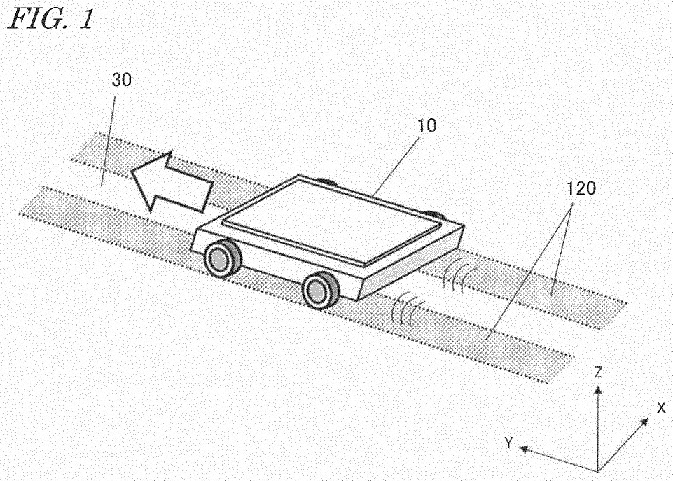

FIG. 1 is a diagram schematically showing an example of a wireless power transmission system of the electric field coupling method. The “electric field coupling method” refers to a method of power transmission in which electric power is wirelessly transmitted from a group of power transmitting electrodes including a plurality of power transmitting electrodes to a group of power receiving electrodes including a plurality of power receiving electrodes through electric field coupling (hereinafter referred to also as “capacitive coupling”) between the group of power transmitting electrodes and the group of power receiving electrodes. For the sake of simplicity, an example where the group of power transmitting electrodes and the group of power receiving electrodes are each composed of a pair of two electrodes. The group of power transmitting electrodes and the group of power receiving electrodes may each include three or more electrodes. In that case, AC voltages of opposite phases are applied to any two electrodes adjacent to each other in each of the group of power transmitting electrodes and the group of power receiving electrodes.

The wireless power transmission system shown in FIG. 1 is a system for wirelessly transmitting electric power to a mobile object 10, which is an automated guided vehicle (AGV). The mobile object 10 may be used for transporting articles in a factory or a warehouse, for example. In this system, a pair of flat plate-shaped power transmitting electrodes 120 are arranged on a floor surface 30. The mobile object 10 includes a pair of power receiving electrodes opposing the pair of power transmitting electrodes 120 when electric power is transmitted. The mobile object 10 uses the pair of power receiving electrodes to receive AC power transmitted from the pair of power transmitting electrodes 120. The received electric power is supplied to a load of the mobile object 10, such as a motor, a secondary battery or a capacitor for storing electricity. Thus, the mobile object 10 is driven or charged.

FIG. 1 shows XYZ coordinates representing the X, Y and Z directions that are orthogonal to each other. The illustrated XYZ coordinates will be used in the following description. The Y direction denotes the direction in which the power transmitting electrodes 120 extend, the Z direction denotes the direction that is perpendicular to the surface of the power transmitting electrodes 120, and the X direction denotes the direction perpendicular to the Y direction and the Z direction, i.e., the width direction of the power transmitting electrodes 120. Note that the directions of structures shown in the figures of the present application are determined in view of the ease of understanding of the description herein, and they do not in any way limit directions to be used when actually carrying out any embodiment of the present disclosure. Also, the shape and size of the whole or part of any structure illustrated in the figures do not limit the actual shape and size thereof.

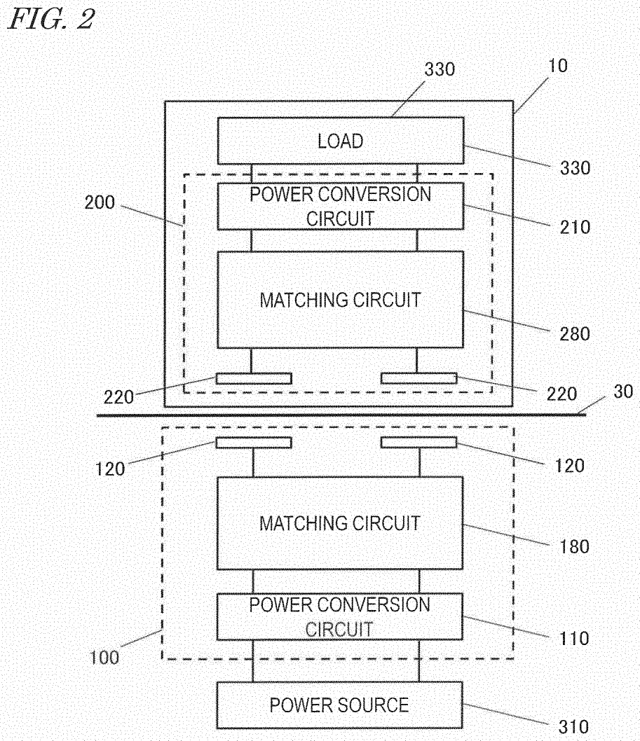

FIG. 2 is a diagram showing a general configuration of the wireless power transmission system shown in FIG. 1. The wireless power transmission system includes a power transmitting device 100 and the mobile object 10.

The power transmitting device 100 includes the pair of power transmitting electrodes 120, a matching circuit 180, and the power conversion circuit 110. The power conversion circuit 110 converts the electric power output from the power source 310 into AC power for transmission, and outputs the converted power. The power conversion circuit 110 may include an AC output circuit such as an inverter circuit, for example. The power conversion circuit 110 converts the DC power supplied from the power source 310 into AC power, and outputs the converted power to the pair of power transmitting electrodes 120. The power source 310 may be an AC power source. In that case, the power conversion circuit 110 converts the AC power supplied from the power source 310 into AC power of a different frequency or voltage, and outputs the converted power to the pair of power transmitting electrodes 120. The matching circuit 180 is connected between the power conversion circuit 110 and the pair of power transmitting electrodes 120. The matching circuit 180 improves the degree of impedance match between the power conversion circuit 110 and the pair of power transmitting electrodes 120.

The mobile object 10 includes a power receiving device 200 and a load 330. The power receiving device 200 includes a pair of power receiving electrodes 220, a matching circuit 280, and a power conversion circuit 210. The power conversion circuit 210 converts the AC power received by the pair of power receiving electrodes 220 into electric power as requested by the load 330, and supplies the converted power to the load 330. The power conversion circuit 210 may include various circuits such as a rectifier circuit or a frequency conversion circuit, for example. The matching circuit 280 for reducing impedance mismatch is inserted between a power receiving electrodes 220 and the power conversion circuit 210.

The load 330 is a component that consumes or stores electric power, such as a motor, a capacitor for storing electricity or a secondary battery, for example. Electric power is wirelessly transferred between the pair of power transmitting electrodes 120 and the pair of power receiving electrodes 220, while they oppose each other, through electric field coupling therebetween. The transferred electric power is supplied to the load 330.

In this example, the power transmitting electrodes 120 are arranged generally parallel to the floor surface 30. The power transmitting electrodes 120 may he arranged so as to cross the floor surface 30. For example, when installed on a wall, the power transmitting electrodes 120 may be arranged substantially vertical to the floor surface 30. The power receiving electrodes 220 of the mobile object 10 may also be arranged so as to cross the floor surface so that the power receiving electrodes 220 oppose the power transmitting electrodes 120. Thus, the arrangement of the power receiving electrodes 220 is determined according to the arrangement of the power transmitting electrodes 120.

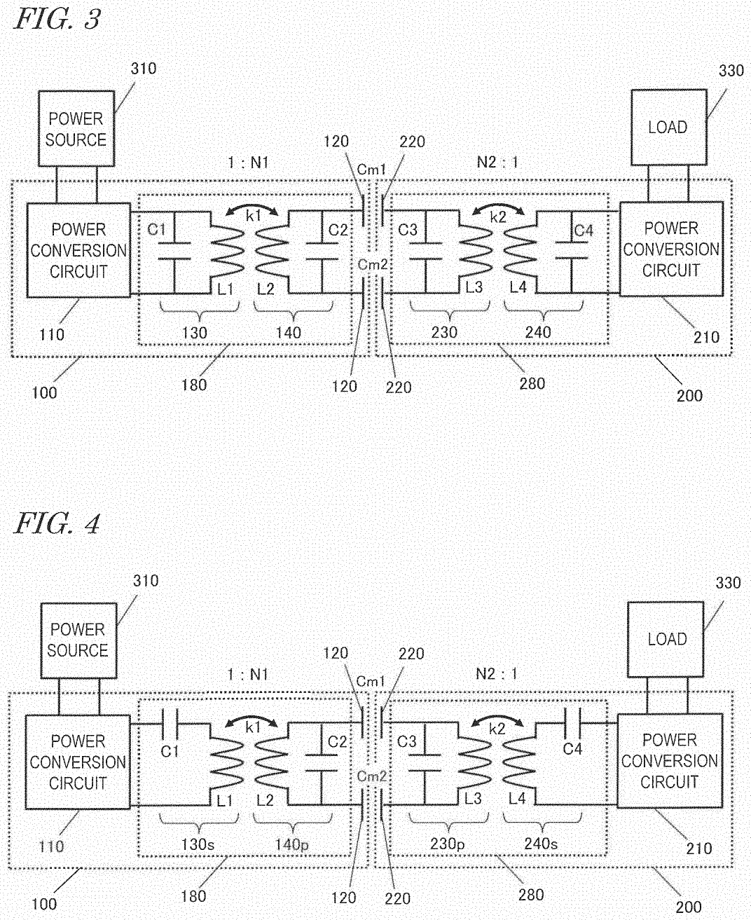

FIG. 3 is a diagram showing an example of a circuit configuration of the matching circuits 180 and 280. This circuit configuration is similar to the configuration disclosed in Patent Document No. 2.

The matching circuit 180 of the power transmitting device 100 includes a first parallel resonance circuit 130 and a second parallel resonance circuit 140. The first parallel resonance circuit 130 is connected to the power conversion circuit 110. The second parallel resonance circuit 140 is arranged between the first parallel resonance circuit 130 and the pair of power transmitting electrodes 120. The second parallel resonance circuit 140 is connected to the pair of power transmitting electrodes 120, and magnetically couples to the first parallel resonance circuit 130. The first parallel resonance circuit 130 has a configuration in which the coil L1 and the capacitor C1 are connected in parallel to each other. The second parallel resonance circuit 140 has a configuration in which the coil L2 and the capacitor C2 are connected in parallel to each other. The coil L1 and the coil L2 together form a transformer with a coupling coefficient k1. The turns ratio (1:N1) between the coil L1 and the coil L2 is set to a value such that a desired transformation ratio is realized.

The matching circuit 280 of the power receiving device 200 includes a third parallel resonance circuit 230 and a fourth parallel resonance circuit 240. The third parallel resonance circuit 230 is connected to the pair of power receiving electrodes 220. The fourth parallel resonance circuit 240 is arranged between the third parallel resonance circuit 230 and the power conversion circuit 210, and magnetically couples to the third parallel resonance circuit 230. The power conversion circuit 210 converts the AC power output from the fourth parallel resonance circuit 240 into DC power, and supplies the converted power to the load 330. The third parallel resonance circuit 230 has a configuration in which the coil L3 and the capacitor C3 are connected in parallel to each other. The fourth parallel resonance circuit 240 has a configuration in which the coil L4 and the capacitor C4 are connected in parallel to each other. The coil L3 and the coil L4 together form a transformer with a coupling coefficient k2. The turns ratio (N2:1) between the coil L3 and the coil L4 is set to a value such that a desired transformation ratio is realized.

The four parallel resonance circuits 130, 140, 230 and 240 have an equal resonance frequency, and the power conversion circuit 110 outputs AC power of a frequency equal to the resonance frequency thereof. Thus, the parallel resonance circuits 130, 140, 230 and 240 are in a resonant state when electric power is transferred.

The power transmitting electrodes 120 and the power receiving electrodes 220 are arranged so as to oppose each other while being close to each other. A dielectric having a high relative dielectric constant may be provided between the power transmitting electrodes 120 and the power receiving electrodes 220. With such a configuration, the capacitances Cm1 and Cm2 between the two power transmitting electrodes 120 and the two power receiving electrodes 220 can be made as high as possible. The reason why electric power is transferred while the capacitances Cm1 and Cm2 are made as high as possible is to make it possible to stably transfer electric power even if the relative position between the power transmitting electrodes 120 and the power receiving electrodes 220 changes. When the capacitances Cm1 and Cm2 are very high, the input/output impedance of the electrodes 120 and 220 is far smaller than the input/output impedance of the parallel resonance circuits 230 and 240 at resonance. As a result, it is possible to reduce the fluctuation of the voltage given to the load 330 even if the relative position between the power transmitting electrodes 120 and the power receiving electrodes 220 changes and the capacitances Cm1 and Cm2 fluctuate.

Thus, with the configuration shown in FIG. 3, there is a need to increase the capacitances Cm1 and Cm2 in order to reduce the input/output impedance of the electrodes 120 and 220. Therefore, the distance between electrodes is decreased as much as possible, and a dielectric having a high dielectric constant is arranged between electrodes.

However, with such a configuration, there is a limitation on the relative positional relationship between the power transmitting device 100 and the power receiving device 200. In order to realize applicability to a wide variety of applications, it is desired that it is possible to maintain a high transmission efficiency even when the gap between electrodes is left as being a gap rather than providing a dielectric therebetween. It is also desired that it is possible to maintain a high transmission efficiency even when the distance between the electrodes 120 and 220 is relatively long (e.g., 5 mm to several tens mm).

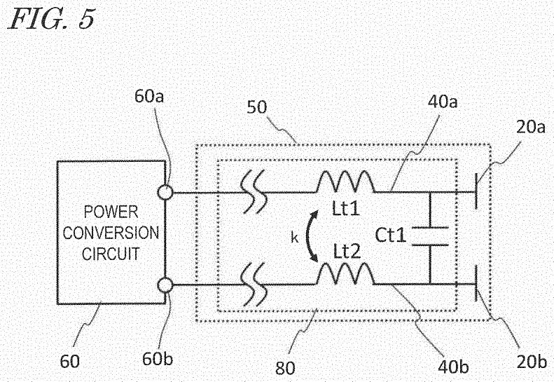

FIG. 4 shows an example of a circuit configuration that can solve the problem described above. In the example of FIG. 4, each of the matching circuits 180 and 280 includes a combination of a series resonance circuit and a parallel resonance circuit. The matching circuit 180 of the power transmitting device 100 includes the series resonance circuit 130s and the parallel resonance circuit 140p. The matching circuit 280 of the power receiving device 200 includes the parallel resonance circuit 230p and the series resonance circuit 240s. With such a configuration, it is easy to realize impedance match even when the capacitance between the electrodes 120 and 220 is small.

With the configuration shown in FIG. 4, it is possible to enhance the degree of impedance match and to improve the power transmission efficiency. However, with further in-depth study, the present inventor arrived at the configuration of a matching circuit with which it is possible to further improve the power transmission efficiency.

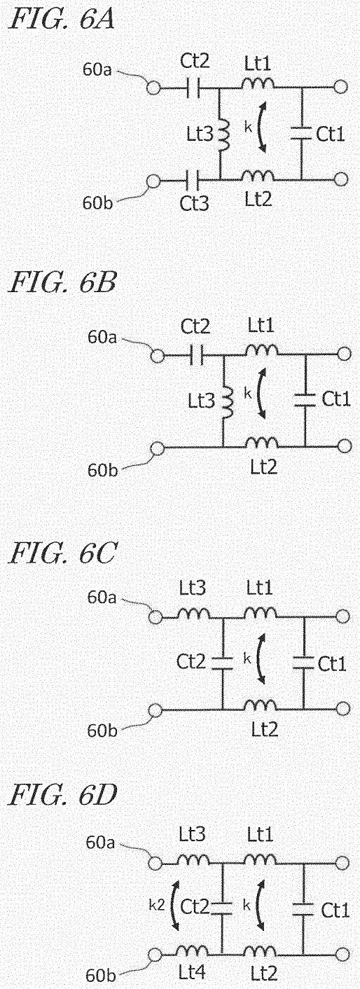

FIG. 5 is a diagram showing an example of a general configuration of an electrode unit including such a matching circuit and two electrodes. This electrode unit 50 is used in a power transmitting device or a power receiving device in a wireless power transmission system of the electric field coupling method. The electrode unit 50 includes a first electrode 20a and a second electrode 20b, which are a power transmitting electrode pair or a power receiving electrode pair, and a matching circuit 80.

When electric power is transferred, voltages of opposite phases are applied to the electrodes 20a and 20b. The term “opposite phases” in the present specification means that the phase difference is greater than 90 degrees and less than 270 degrees. Typically, AC voltages whose phases are different from each other by about 180 degrees are applied to the electrodes 20a and 20b. The matching circuit 80 is connected between a power conversion circuit 60 and the electrodes 20a and 20b in a power transmitting device or a power receiving device.

The power conversion circuit 60 includes a first terminal 60a and a second terminal 60b. Where the power conversion circuit 60 is installed in a power transmitting device, the power conversion circuit 60 converts the electric power output from the power source into AC power for transmission, and outputs the converted power through the first terminal 60a and the second terminal 60b. Where the power conversion circuit 60 is installed in a power receiving device, the power conversion circuit 60 converts the AC power input to the first terminal 60a and the second terminal 60b into another form of electric power that is used by the load to output the converted power.

The matching circuit 80 includes a first inductor Lt1 connected to the first electrode 20a, a second inductor Lt2 connected to the second electrode 20b, and a first capacitor Cfc1. The first capacitor Ct1 is connected between a wire 40a between the first electrode 20a and the first inductor Lt1 and a wire 40b between the second electrode 20b and the second inductor Lfc2. The first capacitor Ct1 may be referred to also as a “parallel capacitive element”. At the terminal that is on the opposite side from the terminal connected to the first electrode 20a, the first inductor Lt1 is to be directly or indirectly connected to the first terminal 60a of the power conversion circuit 60. At the terminal that is on the opposite side from the terminal connected to the second electrode 20b, the second inductor Lt2 is to be directly or indirectly connected to the second terminal 60b of the power conversion circuit 60.

Between the power conversion circuit 60 and the inductor Lt1 or Lt2, a circuit element such as another inductor, a capacitor, a filter circuit or a transformer may be inserted. In that case, the inductor Lt1 or Lt2 are indirectly connected to the terminal 60a or 60b of the power conversion circuit 60.

By providing the electrode unit 50 having the configuration described above in at least one of the power transmitting device and the power receiving device, it is possible to further improve the power transmission efficiency as will be later described in detail.

The coupling coefficient k between the first inductor Lt1 and the second inductor Lt2 may be set to a value that satisfies −1<k<0, for example. As a result, the first inductor Lt1 and the second inductor Lt2 are able to function as a common mode choke filter. In that case, it is possible to reduce common mode noise in the transmission frequency or in a low-order harmonic band. In this case, the resonator formed of the first inductor Lt1, the second inductor Lt2 and the first capacitor Ct1 may be referred to as a “common mode choke resonator”.

A reference sign such as Lt1 and Lt2 representing an inductor will be used, in the following description, also as a sign representing the inductance value of the inductor. Similarly, a reference sign such as Ct1 representing a capacitor will be used also as a sign representing the capacitance value of the capacitor.

In the matching circuit 80 according to an embodiment of the present disclosure, the inductors Lt1 and Lt2 are magnetically coupled with the coupling coefficient k, and as a result, the leakage inductance generated in the pair of inductors Lt1 and Lt2 and the capacitance of the capacitor Ct1 together form a resonance loop. The resonance frequency f0, the inductances Lt1 and Lt2 and the capacitance Ct1 of the common mode choke resonator satisfy the relationship of Expression 1 below.

f0=1/2π\sqrt{(Lt1+Lt2)Ct1} [Expression 1]

In actual design, strictly speaking, there may be a difference between the value of the expression above and the actual resonance frequency because of the influence of circuits to be added on the side of the power conversion circuit 60 and circuits to be added on the side of the electrodes 20a and 20b and the input/output impedance. Even in that case, the design is made such that the resonance frequency generally falls within an error range of 50% of the value of the expression above. The resonance frequency f0 of the common mode choke resonator and the transmission frequency f1 are set to be substantially equal to each other. Therefore, the frequency f1 of the AC power to be transmitted may be set to a value within a range of 0.5 to 1.5 times the value of f0 shown in Expression 1, for example.

In the common mode choke resonator, the inductances Lt1 and Lt2 are set to values that are substantially equal to each other, for example. Assuming that the range of manufacture variation of inductors in general is within ±20%, the difference between the inductances Lt1 and Lt2 is set within 40%, for example. In other words, the difference between Lt1 and Lt2 is smaller than 0.4 times the average value of Lt1 and Lt2. More preferably, the difference between the inductances Lt1 and Lt2 is set within ±10%. In this case, the difference between Lt1 and Lt2 is smaller than 0.1 times the average value of Lt1 and Lt2. With the wireless power transmission system according to an embodiment of the present disclosure, with a limitation on the increase of the electrode area, it is preferred that the voltage phase difference between the electrode 20a and the electrode 20b, which are connected to the output terminal of the common mode choice resonator, is kept at 180 degrees, in order to transfer a large amount of electric power with a small area. Keeping the inductances Lt1 and Lt2 equal to each other leads to the maintenance of circuit symmetry in the wireless power transmission system of an embodiment of the present disclosure, resulting in more preferable effects.

The value of the capacitance value Ct1 of the first capacitor Ct1 is determined based on the relationship between Lt1 and Lt2 as described above.

When electric power is transferred, where V0 is the effective value of the voltage of the AC power output from the power conversion circuit 60 or the AC power Input to the power conversion circuit 60, and V1 is the effective value of the voltage between the first electrode 20a and the second electrode 20b, V1/V0>2.14 is satisfied, for example. For example, the lower limit value 2.14 is the ratio that is obtained where the DC energy obtained by smoothing the AC energy supplied from a 200-V AC power source is used as the power source and where the line-to-line voltage difference is 600 V, which is the AC low voltage reference upper limit value. As another example, V1/V0>4.28 may be satisfied based on the ratio that is obtained where the DC energy obtained by smoothing the AC energy supplied from a 100-V AC power source is used as the power source and where the line-to-lice voltage difference is 600 V, which is the AC low voltage reference upper limit value. As another example, V1/V0<50 may be satisfied based on the ratio that is obtained where the DC energy obtained ts smoothing the AC energy supplied from a 100-V AC power source is used as the power source and where the line-to-line voltage difference is 7000 V, which is the AC high voltage reference upper limit value. As another example, V1/V0<25 may be satisfied based on the ratio that is obtained where the DC energy obtained by smoothing the AC energy supped from a 200-V AC power source is used. as the power source and where the line-to-line voltage difference is 7000 V, which is the AC high voltage reference upper limit value. Needless to say, even when the line-to-line voltage difference takes a value greater than equal to 7000 V, which corresponds to the special high voltage reference, if safety measures are taken, there is no limitation on the upper limit of the range V1/V0 in the design of an embodiment of the present disclosure. When the matching circuit 80 is provided in power transmitting device, the matching circuit 80 functions as a step-up circuit with a step-up ratio of V1/V2. When the matching circuit 80 is provided in the power receiving device, the matching circuit 80 functions as a high voltage circuit with a step-down ratio of V0/V1.

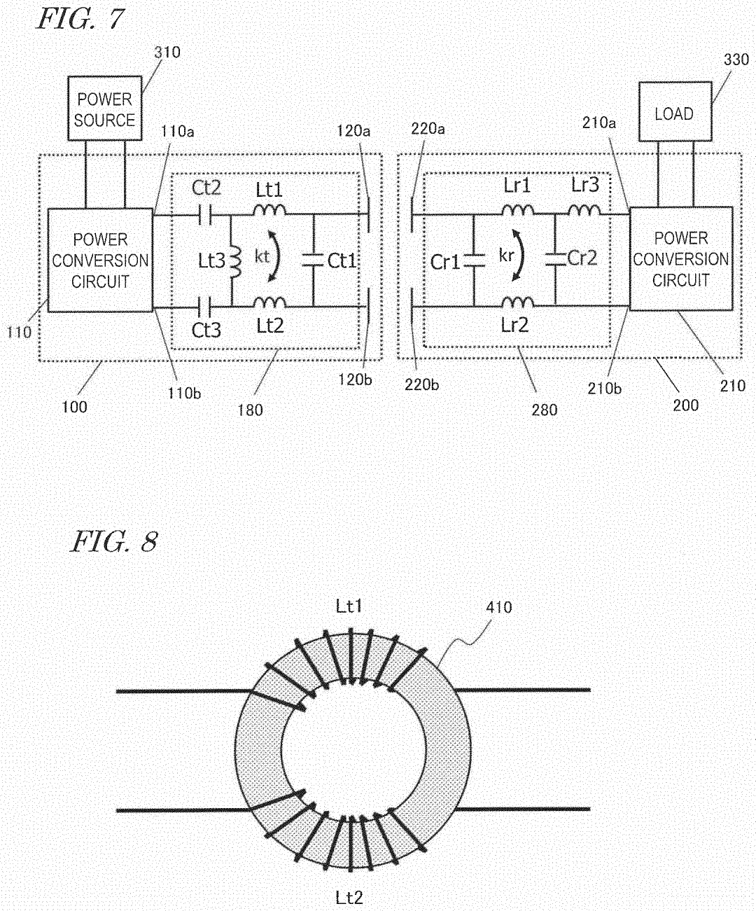

The matching circuit 80 may include circuit elements other than those shown in FIG. 5. Other examples of the matching circuit 80 will be described with reference to FIG. 6A to FIG. 6D.

FIG. 6A is a diagram showing a first variation of the matching circuit 80. The matching circuit 80 further includes a second capacitor Ct2, a third capacitor Ct3 and a third inductor Lt3. The second capacitor Ct2 is connected between the first inductor Lt1 and the first terminal 60a as a series circuit element. The third capacitor Ct3 is connected between the second inductor Lt2 and the second terminal 60b as a series circuit element. The third inductor Lt3 is connected, as a parallel circuit element, between a wire between the first inductor Lt1 and the second capacitor Ct2 and a wire between the second inductor Lt2 and the third capacitor Ct3. It can be said that this configuration is obtained by adding a high-pass filter having a symmetrical circuit configuration to the configuration shown in FIG. 5. With such a configuration, it is possible to further improve the transmission efficiency.

FIG. 6B is a diagram showing a second variation of the matching circuit 80. The matching circuit 80 further includes the second capacitor Ct2 and the third inductor Lt3. The second capacitor Ct2 is connected between the first inductor Lt1 and the first terminal 60a as a series circuit element. The third inductor Lt3 is connected, as a parallel circuit element, between a wire between the first inductor Lt1 and the second capacitor Ct2 and a wire between the second inductor Lt2 and the second terminal 60b. It can be said that this configuration is obtained by adding a high-pass filter having an asymmetrical circuit configuration to the preceding stage of the configuration of the matching circuit shown in FIG. 5. As compared with the configuration of FIG. 6A, it is possible to reduce the number of elements although the positive/negative symmetry of the circuit lowers, and also with such a configuration, it is possible to further improve the transmission efficiency.

FIG. 6C is a diagram showing a third variation of the matching circuit 80. The matching circuit 80 further includes the third inductor Lt3 and the second capacitor Ct2. The third inductor Lt3 is connected between the first inductor Lt1 and the first terminal 60a a series circuit element. The second capacitor Ct2 is connected, as a parallel circuit element between a wire between the first inductor Lt1 and the third inductor Lt3 and a wire between the second inductor Lt2 and the second terminal 60b. It can be said that this configuration is obtained by adding a low-pass filter having an asymmetrical circuit configuration to the preceding stage of the configuration of the matching circuit shown in FIG. 5. Also with such a configuration, it is possible to further improve the transmission efficiency.

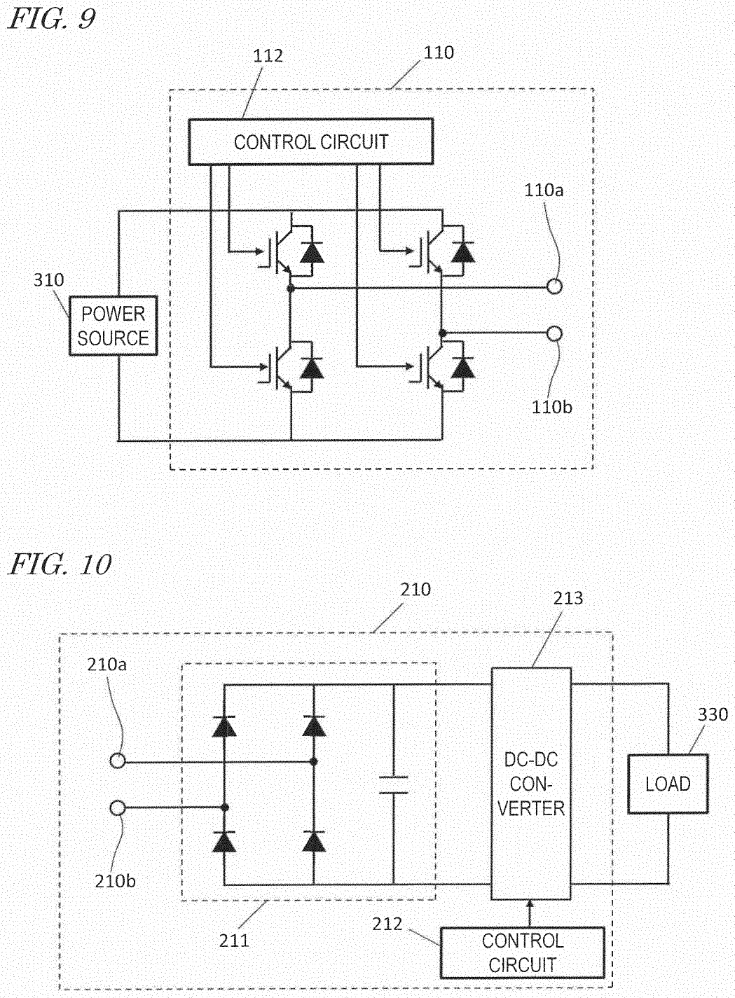

FIG. 6C is a diagram showing a fourth variation of the matching circuit 80. The matching circuit 80 includes the third inductor Lt3, the fourth inductor Lt4 and the second capacitor Ct2. The third inductor Lt3 is connected between the first inductor Lt1 and the first terminal 60a as a series circuit element. The fourth inductor Lt4 is connected between the second inductor Lt2 and the second terminal 60b as a series circuit element. The second capacitor Ct2 is connected, as a parallel circuit element, between a wire between the first inductor Lt1 and the third inductor Lt3 and a wire between the second inductor Lt2 and the fourth inductor Lt4. The third inductor Lt3 and the fourth inductor Lt4 may be designed so that they are coupled together with a negative coupling coefficient, for example. It can be said that this configuration is obtained by adding a low-pass filter having a symmetrical circuit configuration to the configuration shown in FIG. 5. Also with such a configuration, it is possible to further improve the transmission efficiency. Note that the configuration of FIG. 6D can be regarded as being a configuration in which the common mode choke resonator shown in FIG. 7 is used in a multiple-stage connection. The number of stages of the common mode choke resonator to be connected is not limited to two, but it may be three or more.

Each of the matching circuits shown in FIGS. 5 to 6D can be used in a power transmitting device or in a power receiving device. When a matching circuit is used in a power transmitting device, the two terminals shown on the right side of the figure are connected respectively to two power transmitting electrodes, and the terminals 60a and 60b may be terminals of an inverter circuit, for example. When a matching circuit is used in a power receiving device, the two terminals shown on the right side of the figure are connected to two power receiving electrodes, and the terminals 60a and 60b may be terminals of a rectifier circuit, for example.

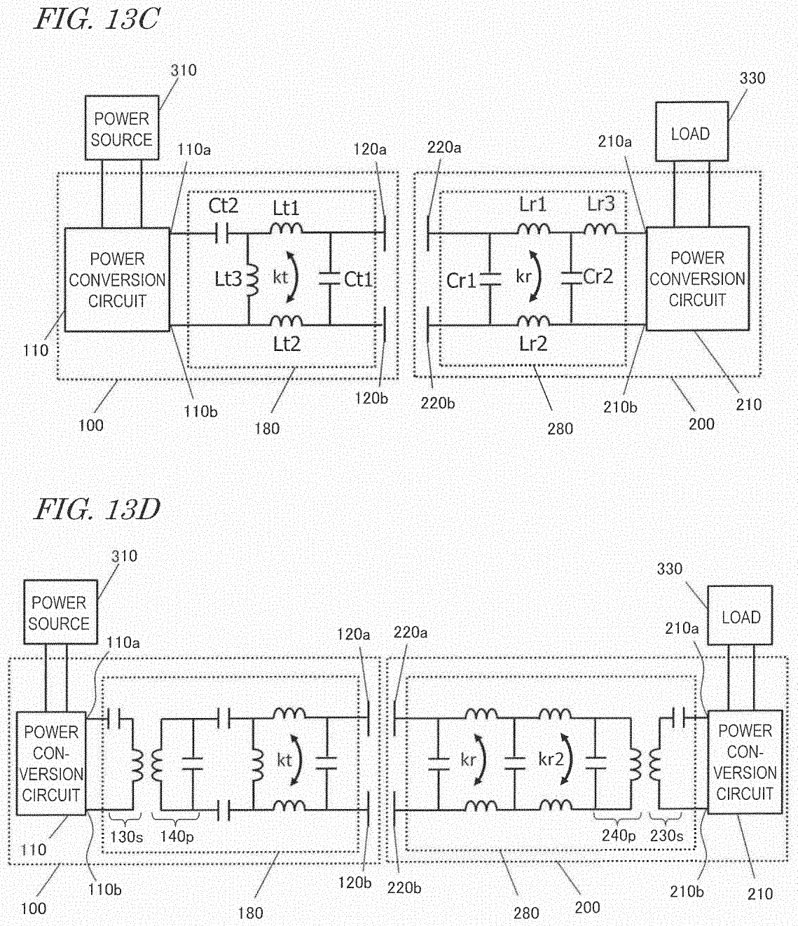

The matching circuits shown in FIGS. 6A to 6D can realize similar advantageous effects also when they are transformed into configurations shown in FIGS. 14A to 14D, respectively.

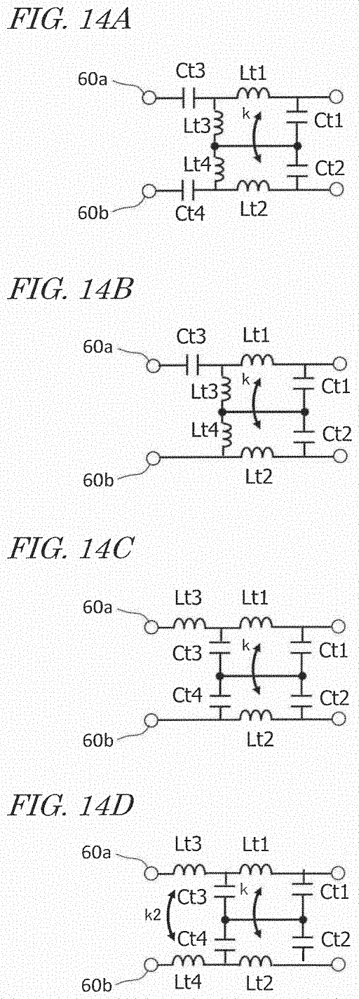

FIG. 14A is a diagram showing a fifth variation of the matching circuit 80. This matching circuit 80 has a configuration in which the inductor Lt3 and the capacitor Ct1 of FIG. 6A are each divided in two, with the points of division connected to each other. With the matching circuit of FIG. 6A, the amplitudes of the potentials generated at the terminals of the opposite poles may differ due to variations in characteristics of the parts used as the inductors Lt1 and Lt2. In that case, as shown in the upper right of FIG. 15, the radiation noise may become large because the midpoint potential fluctuates. In contrast, with the configuration of FIG. 14A, the inductor Lt3 and the inductor Lt4 are set so that they have substantially the same inductance, and the capacitor Ct1 and the capacitor Ct2 are set so that they have substantially the same capacitance. Then, the midpoint potential can be forced to be substantially the same potential. For example, as shown in the lower half of FIG. 15, the voltage amplitudes at the terminals can be made equal. Therefore, the electric fields generated by the potentials of the electrodes connected to the terminals can be canceled out, and it is possible to reduce the radiation noise. Herein, two values “being substantially the same” not only refers to cases where they coincide with each other strictly, but also includes cases where the ratio therebetween is within a range of about 0.9 to 1.1.

FIG. 14B is a diagram showing a sixth variation of the matching circuit 80. This matching circuit 80 has a configuration in which the inductor Lt3 and the capacitor Ct1 of FIG. 6B are each divided in two, with the points of division connected to each other. With the configuration of FIG. 14B, as with the configuration of FIG. 14A, the voltage amplitudes at the terminals can be made equal. Therefore, the electric fields generated by the potentials of the electrodes connected to the terminals can be canceled out, and it is possible to reduce the radiation noise.

FIG. 14C is a diagram showing a seventh variation of the matching circuit 80. This matching circuit 80 has a configuration in which the capacitors Ct2 and Ct1 of FIG. 6C are each divided in two, with the points of division. connected to each other. With the configuration of FIG. 14C, as with the configuration of FIG. 14A, the voltage amplitudes at the terminals can be made equal. Therefore, the electric fields generated by the potentials of the electrodes connected to the terminals can be canceled out, and it is possible to reduce the radiation noise.

FIG. 14D is a diagram showing an eighth variation of the matching circuit 80. This matching circuit 80 has a configuration in which the capacitors Ct2 and Ct1 of FIG. 6C are each divided in two, with the points of division connected to each other. With the configuration of FIG. 14D, as with the configuration of FIG. 14A, the voltage amplitudes at the terminals can he made equal. Therefore, the electric fields generated by the potentials of the electrodes connected to the terminals can be canceled out, and it is possible to reduce the radiation noise.

Note that the configuration of FIG. 14D can be regarded as being a configuration in which the common mode choke resonator shown in FIG. 5 is used in a multiple-stage connection. The number of stages of the common mode choke resonator to be connected is not limited to two, but it may be three or more.

In the present specification, an electrode unit installed in the power transmitting device may be referred to as a “power transmitting electrode module” or a “power transmitting module”, and an electrode unit installed in the power receiving device may be referred to as a “power receiving electrode module” or a “power receiving module”. When the electrode unit is installed in the power transmitting device, the first electrode and the second electrode are referred to as power transmitting electrodes. When the electrode unit is installed in the power receiving device, the first electrode and the second electrode are referred to as power receiving electrodes. When electric power is transferred, a pair of power transmitting electrodes oppose a pair of power receiving electrodes. Electric power is transferred from the pair of power transmitting electrodes to the pair of power receiving electrodes via electric field coupling therebetween.

In each of the power transmitting module and the power receiving module, the first electrode and the second electrode may each be divided into a plurality of portions. The plurality of portions have a structure in which they extend in the same direction and may be arranged generally parallel to each other. AC voltages of the same phase are applied to the plurality of portions. AC voltages of opposite phases to each other are applied to any two adjacent portions of these electrodes. In other words, first electrode portions and second electrode portions are arranged to alternate with each other. With such a configuration, it is possible to also realize the effect of suppressing the leak electric field over the boundary between the first electrode and the second electrode. With a configuration in which at least one of the first and second electrodes is divided into two portions, there are essentially three or more electrodes that contribute to power transmission. When referring to such a configuration, the three electrodes will be referred to as “a group of electrodes”.

A power transmitting device according to another aspect of the present disclosure includes the power transmitting module described above and the power conversion circuit. The power conversion circuit converts the electric power output from the power source into the AC power and outputs the converted power. The power conversion circuit in the power transmitting device may include an inverter circuit and a control circuit for controlling the inverter circuit, for example. The control circuit may control the inverter circuit to output a constant level of electric power.

A power receiving device according to still another aspect of the present disclosure includes the power receiving module described above and the power conversion circuit. The power conversion circuit converts the AC power output from the matching circuit into the other form of electric power and outputs the converted power. The power conversion circuit in the power receiving device includes a rectifier circuit, a DC-DC converter connected to the rectifier circuit, and a control circuit for controlling the DC-DC converter. The control circuit may perform a control so that a constant level of electric power is output from the DC-DC converter.

A wireless power transmission system according to still another aspect of the present disclosure includes the power transmitting device described above and the power receiving device described above. Power transmission via air may be done between at least two power transmitting electrodes in the power transmitting device and at least two power receiving electrodes in the power receiving device.

The present inventors found that particularly superior characteristic can be realized when the power transmitting device has a circuit configuration of a high-pass filter illustrated in FIG. 6A or FIG. 6B and the power receiving device has a circuit configuration of a low-pass filter illustrated in FIG. 6C or FIG. 6D. With such a configuration, even if the interval between the power transmitting electrode and the power receiving electrode fluctuates, it is possible to suppress the fluctuation of voltage between the power transmitting electrodes and between the power receiving electrodes, and to suppress the decrease in transmission efficiency.

Such a power transmitting module and such a power receiving module have the following configuration.

A power transmitting module according to one aspect of the present disclosure includes: a first electrode and a second electrode, which are a power transmitting electrode pair; and a matching circuit to be connected between a power conversion circuit and the first and second electrodes in the power transmitting device. The power conversion circuit includes a first terminal and a second terminal and converts electric power output from a power source into AC power for transmission to output the converted power from the first and second terminals. The matching circuit includes: a first inductor connected to the first electrode; a second inductor connected to the second electrode; a first capacitor connected between a wire between the first electrode and the first inductor and a wire between the second electrode and the second inductor; a second capacitor connected to the first inductor; and a third inductor connected between a wire between the first inductor and the second capacitor and a wire connected to the second inductor. On an opposite side from the first electrode, the second capacitor is to be directly or indirectly connected to the first terminal of the power conversion circuit. On an opposite side from the second electrode, the second inductor is to be directly or indirectly connected to the second terminal of the power conversion circuit.

The matching circuit in the power transmitting module further may include a third capacitor connected to the second inductor. The third inductor is connected between a wire between the first inductor and the second capacitor and a wire between the second inductor and the third capacitor. On an opposite side from the second electrode, the third capacitor is to be directly or indirectly connected to the second terminal of the power conversion circuit.

A power transmitting module according to another aspect of the present disclosure includes: a first electrode and a second electrode, which are a power transmitting electrode pair; and a matching circuit to be connected between a power conversion circuit and the first and second electrodes in the power transmitting device. The power conversion circuit includes a first terminal and a second terminal and converts electric power output from a power source into AC power for transmission to output the converted power from the first and second terminals. The matching circuit includes: a first inductor connected to the first electrode; a second inductor connected to the second electrode; a first capacitor connected between a wire between the first electrode and the first inductor and a wire between the second electrode and the second inductor; a third inductor connected to the first inductor; and a second capacitor connected between a wire between the first inductor and the third inductor and a wire connected to the second inductor. On an opposite side from the first electrode, the third inductor is to be directly or indirectly connected to the first terminal of the power conversion circuit. On an opposite side from the second electrode, the second inductor is to be directly or indirectly connected to the second terminal of the power conversion circuit.

The matching circuit may further include a fourth inductor connected to the second inductor. In that case, the second capacitor is connected between a wire between the first inductor and the third inductor and a wire between the second inductor and the fourth inductor. On an opposite side from the second electrode, the fourth inductor is to be directly or indirectly connected to the second terminal of the conversion circuit.

A power receiving module according to another aspect of the present disclosure includes: a first electrode and a second electrode, which are a power receiving electrode pair; and a matching circuit to connected between a power conversion circuit and the first and second electrodes in the power receiving device. The power conversion circuit includes a first terminal and a second terminal and converts AC power input to the first and second terminals into another form of electric power that is used by a load to output the converted power. The matching circuit includes: a first inductor. connected to the first electrode; a second inductor connected to the second electrode; a first capacitor connected between a wire between the first electrode and the first inductor and a wire between the second electrode and the second inductor; a third inductor connected to the first inductor; and a second capacitor connected between a wire between the first inductor and the third inductor and a wire connected to the second inductor. On an opposite side from the first electrode, the third inductor is to be directly or indirectly connected to the first terminal of the power conversion circuit. On an opposite side from the second electrode, the second inductor is to be directly or indirectly connected to the second terminal of the power conversion circuit.

The matching circuit in the power receiving module may further include a fourth inductor connected to the second inductor. The second capacitor is connected between a wire between the first inductor and the third inductor and a wire between the second inductor and the fourth inductor. On an opposite side from the second electrode the fourth inductor is to he directly or indirectly connected to the second terminal of the power conversion circuit.

A power receiving module according to another aspect of the present disclosure includes: a first electrode and a second electrode, which are a power receiving electrode pair; and a matching circuit to be connected between a power conversion circuit and the first and second electrodes in the power receiving device. The power conversion circuit includes a first terminal and a second terminal and converts AC power input to the first and second terminals into another form of electric power that is used by a load to output the converted power. The matching circuit includes: a first inductor connected to the first electrode; a second inductor connected to the second electrode; a first capacitor connected between a wire between the first electrode and the first inductor and a wire between the second electrode and the second inductor; a second capacitor connected to the first inductor; and a third inductor connected between a wire between the first inductor and the second capacitor and a wire connected to the second inductor. On an opposite side from the first electrode, the second capacitor is to be directly or indirectly connected to the first terminal of the power conversion circuit. On an opposite side from the second electrode, the second inductor is to be directly or indirectly connected to the second terminal of the power conversion circuit.

The matching circuit may further include a third capacitor connected to the second inductor. In that case, the third inductor is connected between a wire between the first inductor and the second capacitor and a wire between the second inductor and the third capacitor. On an opposite side from the second electrode, the third capacitor is to be directly or indirectly connected to the second terminal of the power conversion circuit.

The power receiving device may be installed on a mobile object, for example. The “mobile object” as used herein is not limited to a vehicle such as a transport robot set forth above, but refers to any movable object that is driven by electric power. The mobile object includes a powered vehicle that includes an electric motor and one or more wheels, for example. Such a vehicle can be an automated guided vehicle (AGV) such as a transport robot set forth above, an electric car (EV), an electric cart, or an electric wheelchair, for example. The “mobile object” as used herein also includes a movable object that does not include wheels. For example, the “mobile object” includes biped walking robots, unmanned aerial vehicles (UAVs, so-called “drones”) such as multicopters, manned electric aircrafts, and elevators.

Embodiments of the present disclosure will now be described in greater detail. Note however that unnecessarily detailed descriptions may be omitted. For example, detailed descriptions on what are well known in the art and redundant descriptions on substantially the same configurations may be omitted. This is to prevent the following description from becoming unnecessarily redundant, to make it easier for a person of ordinary skill in the art to understand. Note that the present inventors provide the accompanying drawings and the following description in order for a person of ordinary skill in the art to sufficiently understand the present disclosure, and they are not intended to limit the subject matter set forth in the claims. In the following description, identical or similar components are denoted by the same reference signs.

### Embodiments

FIG. 7 is a diagram showing a configuration of a wireless power transmission system according an exemplary embodiment of the present disclosure. The wireless power transmission system of the present embodiment is used in an application of a power supply for the mobile object 10 described above with reference to FIG. 1 and FIG. 2.

The wireless power transmission system includes the power transmitting device 100 and the power receiving device 200. FIG. 7 also shows the power source 310 and the load 330, which are external elements to the present system. The power source 310 and the load 330 may be included in the wireless power transmission system.

The power transmitting device 100 includes the first power conversion circuit 110, a first matching circuit 180 and two power transmitting electrodes 120a and 120b. The first matching circuit 180 is connected between the first power conversion circuit 110 and two power transmitting electrodes 120a and 120b. The first matching circuit 180 has a similar configuration to the configuration shown in FIG. 6A. The first matching circuit 180 includes the inductors Lt1, Lt2 and Lt3 and the capacitors Ct1, Ct2 and Ct3. The inductor Lt1 is connected to the power transmitting electrode 120a. The inductor Lt2 is connected to the power transmitting electrode 120b. The capacitor Ct2 is connected between the inductor Lt1 and one terminal 110a of the power conversion circuit 110 in a series arrangement. The capacitor Ct3 is connected between the inductor Lt2 and the other terminal 110b of the power conversion circuit 110 in a series arrangement. The capacitor Ct1 is connected, in a parallel arrangement, between a wire between the electrode 120a and the inductor Lt1 and a wire between the electrode 120b and the inductor Lt2. The inductor Lt3 is connected, in a parallel arrangement, between a wire between the inductor Lt1 and the capacitor Ct2 and a wire between the inductor Lt2 and the capacitor Ct3. Thus, the power transmitting electrode 120a, the inductor Lt1 and the capacitor Ct2 are connected in series. The power transmitting electrode 120b, the inductor Lt2 and the capacitor Ct3 are connected in series. The capacitor Ct1 and the inductor Lt3 are connected in parallel.

The power receiving device 200 includes two power receiving electrodes 220a and 220b, a second matching circuit 280 and a second power conversion circuit 210. The second matching circuit 280 is connected between the two power receiving electrodes 220a and 220b and the second power conversion circuit 210. The second matching circuit 280 has a similar configuration to the configuration shown in FIG. 6C. The second matching circuit 280 includes the inductors Lr1, Lr2 and Lr3 and capacitors Cr1 and Cr2. The inductor Lr1 is connected to the power receiving electrode 220a. The inductor Lr2 is connected to the power receiving electrode 220b. The capacitor Cr1 is connected between a wire between the inductor Lr1 and the power receiving electrode 220a and a wire between the inductor Lr2 and the power receiving electrode 220b. The inductor Lr3 is connected between the inductor Lr1 and one terminal 210a of the power conversion circuit 210. The capacitor Cr2 is connected between a wire between the inductor Lr1 and the inductor Lr3 and a wire between the inductor Lr2 and the other terminal 210b of the power conversion circuit 210.

The components of the present embodiment will now be described in greater detail. In the following description, the power transmitting electrodes 120a and 120b may be referred to as “the power transmitting electrode 120” without distinguishing them from each other. Similarly, the power receiving electrodes 220a and 220b may be referred to as “the power receiving electrode 120” without distinguishing them from each other.

There is no particular limitation on the sizes of the housing of the mobile object 10, the power transmitting electrodes 120a and 120b and the power receiving electrodes 220a and 220b shown in FIG. 1, and they may be set to the following sizes, for example. The lengths (sizes in the Y direction shown in FIG. 1) of the power transmitting electrodes 120a and 120b may be set within a range of 50 cm to 20 m, for example. The widths (the size in the X direction shown in FIG. 1) of the power transmitting electrodes 120a and 120b may be set within a range of 0.5 cm to 1 m, for example. The size of the housing of the mobile object 10 in the direction of travel and that in the transverse direction may each be set within a range of 20 cm to 5 m, for example. The length (the size in the direction of travel) of each of the power receiving electrodes 220a and 220b may be set within a range of 5 cm to 2 m, for example. The width (the size in the transverse direction) of each of the power receiving electrodes 220a and 220b may be set within a range of 2 cm to 2 m, for example. The gap between the pair of power transmitting electrodes and the gap between the pair of power receiving electrodes may be set within a range of 1 mm to 40 cm, for example. The distance between the power transmitting electrodes 120a and 120b and the power receiving electrodes 220a and 220b may be about 5 mm to 30 mm, for example. Note however that there is no limitation to these numerical range.

The load 330 may include a driving electric motor, a capacitor or a secondary battery for storing electricity, for example. The load 330 is driven or charged by the DC power output from the power conversion circuit 210.

The electric motor may be any motor such as a DC motor, a permanent magnet synchronous motor, an induction motor, a stepper motor and a reluctance motor. The motor rotates the wheels of the mobile object 10 via shafts, gears, etc., to move the mobile object 10. Depending on the type of the motor, the power conversion circuit 210 may include various types of circuits such as a rectifier circuit, an inverter circuit, a DC-DC converter, and a control circuit for controlling the inverter and the DC-DC converter. In order to drive an AC motor, the power conversion circuit 210 may include a converter circuit for directly converting the frequency of the received energy (i.e., AC power) to the frequency for driving the motor.

The power storage capacitor may be a high-capacity, low-resistance capacitor such as an electric double layer capacitor or a lithium ion capacitor, for example. By using such a capacitor as a condenser, it is possible to realize faster charging than when a secondary battery is used. A secondary battery such as a lithium ion battery may be used instead of a capacitor. In that case, more energy can be stored although charging will take longer. The mobile object 10 drives the motor using the electric power stored in a power storage capacitor or a secondary battery to move around.

As the mobile object 10 moves, the amount of electric power stored in the power storage capacitor or the secondary battery decreases. Therefore, recharging is needed to keep moving. In view of this, when the charging amount decreases below a predetermined threshold value while moving, the mobile object 10 moves close to the power transmitting device 100 for charging. The moving may be done under control of a central control device (not shown), or may be done by autonomous decision of the mobile object 10. The power transmitting device 100 may be installed at a plurality of locations in a factory.

The matching circuit 180 of the power transmitting device 100 matches the output impedance of the power conversion circuit 110 and the input of the power transmitting electrodes 120a and 120b with each other. The inductor Lt1 and the inductor Lt2 may function as a common mode choke filter with a predetermined coupling coefficient. The inductance values of these inductors Lt1 and Lt2 are set to values that are substantially equal to each other.

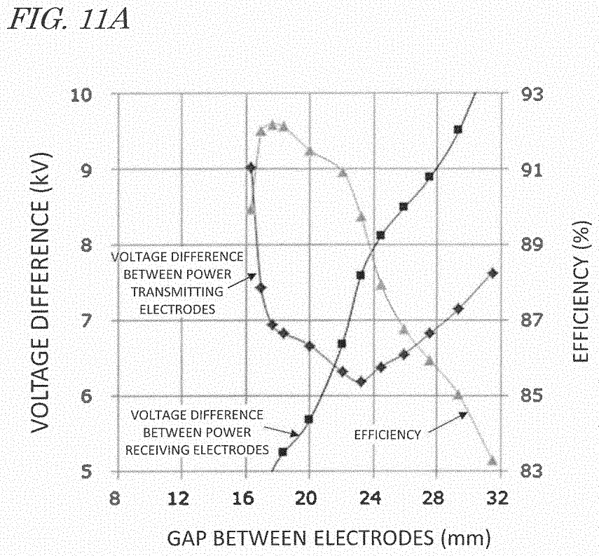

FIG. 8 is a diagram schematically showing a configuration example of two inductors Lt1 and Lt2. In this example, the two inductors Lt1 and Lt2 are wound around a core 410, which is a ring-shaped or toroidal-shaped magnetic material. The core 410 may be a soft-magnetic ferrite core, for example. The inductors Lt1 and Lt2 are arranged in an orientation that realizes a negative coupling coefficient via the core 410. Specifically, −1<k<0 where k is the coupling coefficient of the inductors Lt1 and Lt2. As the coupling coefficient k is closer to −1, more desirable characteristics are realized in view of transmission efficiency. When currents of the same phase are input to the inductors Lt1 and Lt2 through the input/output terminals on the left side of FIG. 8, currents of the same phase will not be output to the right-side output terminals on the right side of FIG. 8. With such a configuration, it is possible to reduce the probability that a common mode noise, which may be generated in the preceding stage of the circuit, is transferred to subsequent stages.

The inductors Lt1 and Lt2 do not always need to have a structure as shown in FIG. 8. Each of the inductors Lt1 and Lt2 may employ a hollow structure in order to realize a low loss characteristic. Note that the coupling coefficient can be measured by a method defined in JTS C5321, for example.

The capacitor Ct1 may be designed so as to resonate between leakage inductances of the inductors Lt1 and Lt2. The resonance frequency of the common mode choice resonance circuit formed by the inductors Lt1 and Lt2 and the capacitor Ct1 may be designed to be a value that is equal to the frequency f1 of the AC power output from the power conversion circuit 110. This resonance frequency may be set to a value within a range of about 50% to 150% of the transmission frequency f1, for example. The power transmission frequency f1 may be set to 50 Hz to 300 GHz, for example, to 20 kHz to 10 GHz in an example, to 20 kHz to 20 MHz in another example, and to 80 kHz to 14 MHz in yet another example.

The capacitors Ct2 and Ct3 and the inductor Lt3 function as a high-pass filter. The capacitances of the capacitors Ct2 and Ct3 may be set to values greater than the capacitance of the capacitor Ct1. The inductance of the inductor Lt3 may be set to a value smaller than the inductances of the inductors Lt1 and Lt2.

The inductors Lr1 and Lr2 and the capacitor Cr1 in the power receiving device 200 also nave a similar configuration to the inductors Lt1 and Lt1 and the capacitor Cr1 in the power transmitting device 100. In an example, the coupling coefficient kr between the inductors Lr1 and Lr2 satisfies −1<kr<0. The inductor Lr3 and the capacitor Cr2 function as a low-pass filter. The inductance of the inductor Lr3 may be set to a value smaller than the inductances of the inductors Lr1 and Lr2. The capacitance of the capacitor Cr2 may be set to a value greater than the capacitance of the capacitor Cr1.

Each of the inductors Lt1, Lt2, Lt3, Lr1, Lr2 and Lt3 may be a winding coil using a litz wire or a twisted wire formed of a material such as copper or aluminum, for example. A planar coil or a laminated coil formed on a circuit board may be used. Any type of a capacitor that has a chip shape or a lead shape, for example, may be used for the capacitors Ct1, Ct2, Ct2, Cr1 and Ct2. Capacitance between two wires with air interposed therebetween may be used as the capacitors.

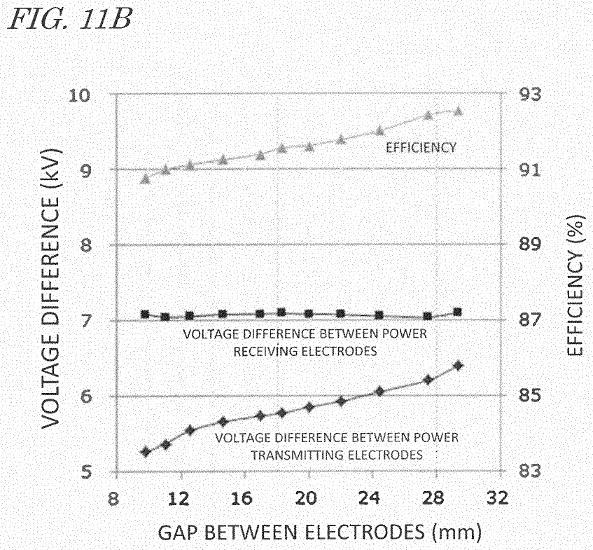

FIG. 9 is a diagram schematically showing a configuration example of the power conversion circuit 110 in the power transmitting device 100. In this example, the power source 310 is a DC power source. The power conversion circuit 110 includes a full-bridge inverter circuit including four switching elements, and a control circuit 112. Each switching element may be implemented by a transistor such as an IGBT or a MOSFET, for example. The control circuit 112 includes a gate driver that outputs a control signal for controlling the conductive (ON) state and the non-conductive (OFF) state of the switching elements, and a processor that causes the gate driver to output the control signal. The processor may be a CPU in a microcontroller unit (MCU), for example. A half-bridge inverter circuit or another oscillator circuit such as a class E may be used instead of a full-bridge inverter circuit shown in FIG. 9.

The power conversion circuit 110 may include other elements such as modulation/demodulation circuit for communication and various sensors for measuring the voltage, the current, etc. When the power conversion circuit 110 includes a modulation/demodulation circuit for communication, it is possible to transmit data to the power receiving device 200 while superimposing the data on AC power. When the power source 310 is an AC power source, the power conversion circuit 110 converts the input AC power into AC power for power transmission having a different frequency or voltage.

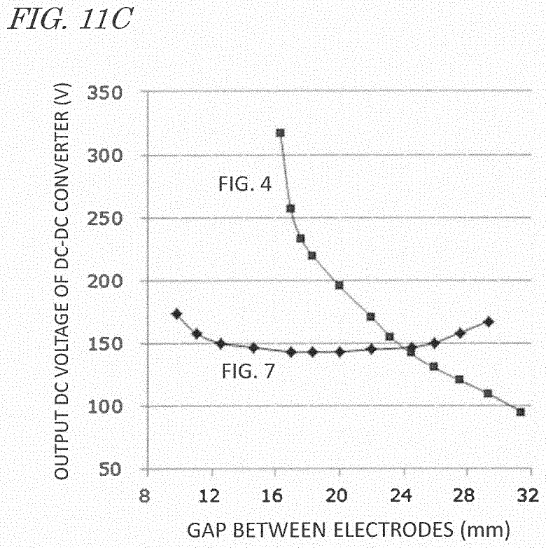

FIG. 10 is a diagram schematically showing a configuration example of the power conversion circuit 210 in the power receiving device 200. In this example, the power conversion circuit 210 includes a rectifier circuit 211, a DC-DC converter 213 and a control circuit 212. The rectifier circuit 211 in this example is a full-wave rectifier circuit including a diode bridge and a smoothing capacitor. The DC-DC converter 213 converts the DC power output from the rectifier circuit 211 into another DC power as requested by the load 330. The control circuit 212 controls the DC power output from the DC-DC converter 213. The control circuit 212 controls the output electric power of the DC-DC converter 213 so as to keep it constant, for example. The control circuit 212 may be realized by a circuit including a processor and a memory such as a microcontroller unit (MCU), for example.

The power conversion circuit 210 may have another rectifier configuration. The power conversion circuit 210 may additionally include various circuits such as a constant voltage/constant current control circuit and a modulation/demodulation circuit for communication. The power conversion circuit 210 converts the received AC energy into DC energy that can be used by the load 330. Various sensors for measuring the voltage, the current, etc., may be included in the power conversion circuit 210. When the energy used by the load 330 is AC energy, the power conversion circuit 210 is configured so as to output AC energy rather than DC.

The power source 310 may be any power source such as a commercial power source, a primary battery, a secondary battery, a solar battery, a fuel battery, a USB (Universal Serial Bus) power source, a high-capacity capacitor (e.g., an electric double layer capacitor), a voltage converter connected to a commercial power source, for example. The power source 310 may be a DC power source or an AC power source.

Next, advantageous effects of the present embodiment will be described.

In the present embodiment, as opposed to the examples shown in FIG. 3 and FIG. 4, the matching circuits 180 and 280, which are required to have a high-ratio step-up/step-down characteristic, do not have a configuration in which a transformer is inserted in series. In the examples of FIG. 3 and FIG. 4, the inductance ratios L2/L1 and L3/L4 need to be set high in order to realize a high step-up ratio or step-down ratio. For example, in the example of FIG. 3, the inductance ratios L2/L1 and L3/L4 can foe values as high as about several tens. Also in the example of FIG. 4, the inductance ratios L2/L1 and L3/L4 can be values of about 2 to 5. It is difficult to improve the Q value of an inductor having a low inductance, and there is a limitation on improving the Q value of an inductor having a high inductance. The loss from the insertion of a transformer is also strongly dependent on the amplitude of the coupling coefficient between inductors forming the transformer. Therefore, a pair of inductors are required to be coupled together strongly. In these examples, it is difficult to realize a low-loss transformer using a combination of low-loss inductors. Moreover, using an inductor having a high inductance leads to a decrease in the self-resonance frequency, which likely leads to a leakage of harmonic noise.

In contrast, in the embodiment shown in FIG. 7, the inductances Lt1 and Lt2 are set to values that are substantially equal to each other, and the inductance Lr1 and Lr2 are also set to values that are substantially equal to each other. Inductors of generally equal inductances can easily toe formed with generally equal sizes, e.g., inner diameters, and as a result, it is easy to enhance the coupling between the inductors. It also eliminates the restriction that a loss of one inductor results in a loss of the inductor pair as a whole. Thus, it is possible to easily realize a high-efficiency matching circuit using a combination of low-loss inductors.

Moreover, the present embodiment also realizes the effect of reducing noise. With the configuration where an inductor is inserted in series along a path that leads to each electrode, harmonic noise is suppressed. Particularly, when the coupling coefficient between the inductors Lt1 and Lt2 and the coupling coefficient between the inductors Lr1 and Lr2 are designed in the range of greater than −1 and less than −0, the noise suppressing effect becomes more pronounced.

Moreover in the present embodiment, the matching circuit 180 in the power transmitting device 100 includes a combination of a high-pass filter and a common mode choke resonator, and the matching circuit 280 in the power receiving device 200 includes a combination of a low-pass filter and a common mode choke resonator. It was found that with such a structure, it is possible to realize a stable power transmission characteristic even if the coupling capacitance between the power transmitting electrode 120 and the power receiving electrode 220 fluctuates. The fluctuation of the coupling capacitance occurs, for example, due to the fluctuation of the distance between the power transmitting electrode 120 and the power receiving electrode 220 (which may be referred to hereinafter as the “electrode-to-electrode gap” or the “electrode-to-electrode distance”). The fluctuation of the coupling capacitance does not always occur only due to the fluctuation of the electrode-to-electrode distance, but may occur also due to the fluctuation of the relative position between the transmitting and receiving electrodes in the X-axis direction, for example.

The present inventors conducted a simulation to check the change in the transmission characteristic when the coupling capacitance between electrodes is changed by changing the electrode-to-electrode gap for the configuration shown in FIG. 4 and the configuration shown in FIG. 7.

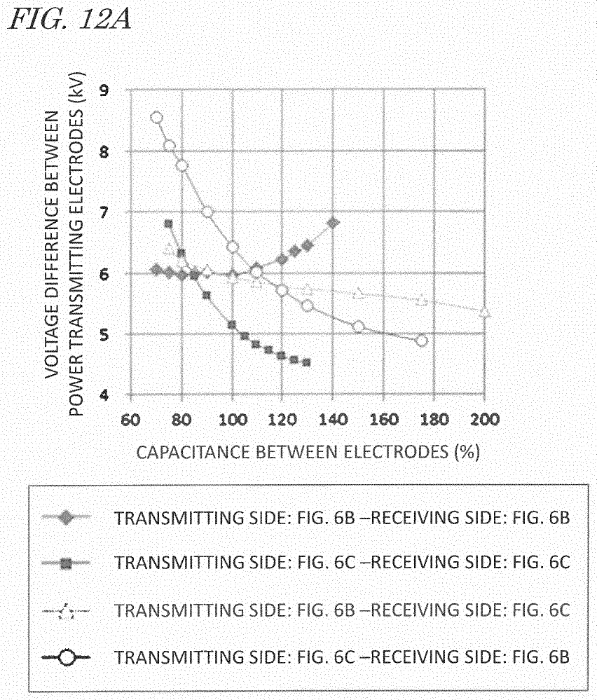

FIG. 11A shows the simulation results obtained when the circuit configuration shown in FIG. 4 is employed. FIG. 11A is a graph showing the electrode-to-electrode gap dependence of the voltage difference between power transmitting electrodes, the voltage difference between power receiving electrodes and the transmission efficiency. The simulation conditions in this example are as follows. The initial opposing distance between the transmitting and receiving electrodes was 22 mm, and the coupling capacitance between the transmitting and receiving electrodes in that case was 83 pF. The transmission frequency was 485 kHz, and the input DC voltage was 200 V. Characteristics are shown for a case where for the output electric power, a voltage conversion control was performed at the DC/DC converter 213 subsequent to the rectifier circuit 211 shown in FIG. 10 so that a constant electric power of 2 kW was output under each condition.

As shown in FIG. 11A, in this example, when the electrode-to-electrode gap changes, the voltage difference between power transmitting electrodes, the voltage difference between power receiving electrodes and the efficiency fluctuate significantly. For example, the voltage difference between power receiving electrodes increases rapidly as the electrode-to-electrode gap increases. Conversely, as the electrode-to-electrode gap is decreased, the voltage difference between power transmitting electrodes increases rapidly. The increase in the electrode-to-electrode voltage difference can lead to deterioration of insulation in the power transmitting electrode and/or in the power receiving electrode. In order to solve this problem, it is necessary to increase the electrode area or to re-design the electrode-to-electrode distance to be narrower. However, either solution can significantly detract from the industrial applicability. As the electrode-to-electrode gap increases, the efficiency lowers and the amount of heat generation increases. As shown in FIG. 11A, even when the electrode-to-electrode gap decreases to 16 mm, the efficiency decreases rapidly and the heat generation increases. Due to these characteristics, there is a limitation on the range of electrode-to-electrode gaps with which desirable characteristics are realized in operation.

The aspect that particularly hinders reduction in size of a circuit will be described in detail. Under the condition where the electrode-to-electrode gap is 30 mm in the figure, the voltage difference between power receiving electrodes reaches 10 kV. For example, in order to satisfy the AC high voltage reference upper limit value of 7 kV, the opposing capacitance between the transmitting and receiving electrodes needs to be increased to (10/7)²≈2 times. If it is not allowed to decrease the opposing distance between the transmitting and receiving electrodes, it is necessary to double the crossing area between the transmitting and receiving electrodes. This will lead to an increase the size of the circuit.

FIG. 11B is a diagram showing the simulation result in a case where the configuration of the present embodiment shown in FIG. 7 is employed. The simulation conditions in this example are the same as the conditions of FIG. 11A.

As shown in FIG. 11B, in this example, the change in the voltage difference between power transmitting electrodes, the voltage difference between power receiving electrodes and the efficiency is small relative to the change in the electrode-to-electrode gap. Therefore, assuming a use in an application in which the range of fluctuation of the electrode-to-electrode gap is wide (e.g., 16 mm or more and 29 mm or less), the worst conditions are significantly eased compared with the characteristics of FIG. 11A for both characteristics, i.e., the voltage difference between transmitting and receiving electrodes and the efficiency. Therefore, it is possible to easily avoid problems such as deterioration of insulation or worsening of heat radiation without taking a solution that detracts from the industrial applicability, such as increasing the crossing area between the transmitting and receiving electrodes or reducing the opposing distance between the transmitting and receiving electrodes. As compared with the characteristics of FIG. 11A, the electrode-to-electrode voltage difference does not fluctuate significantly with the characteristics of FIG. 11B. Therefore, it is easy to grasp the distribution cf the electric field leaking around the power transmitting electrode and the power receiving electrode. For example, with the characteristics of FIG. 11A, since the electrode-to-electrode voltage difference exhibits a complicated behavior, it is difficult to determine under which one of the conditions, i.e., the electrode-to-electrode gap being 16 mm, 22 mm and 28 mm, the leakage to peripheral devices becomes worst. On the other hand, with the characteristics of FIG. 11B, the electrode-to-electrode voltage difference on the power receiving side is not dependent on the electrode-to-electrode gap but is substantially constant. The electrode-to-electrode voltage difference on the power transmitting side monotonously changes relative to the electrode-to-electrode gap, and the slope of the graph is more gentle as compared with the characteristics of FIG. 11A. Therefore, the evaluation conditions for estimating the influence of interference on peripheral devices can be determined and addressed early, and one can expect the effect of reducing the development man-hour.

In the wireless power transmission system, various control parameters such as the input voltage and the transmission frequency may be used in order to control the output electric power or the output voltage. The advantageous effect that is characteristic of the present embodiment is effective for the strong dependence of the voltage difference therebetween the transmitting and receiving electrodes on the coupling capacitance between the transmitting and receiving electrodes under the condition of outputting a constant electric power. Particularly, a high applicability is achieved for a system for maintaining the output of a constant electric power by controlling the load resistance value on the output side. Therefore, as shown in FIG. 10, in the wireless power transmission system of the present embodiment, the DC-DC converter 213 is connected to the output terminal of the rectifier circuit 211.

FIG. 11C is a graph showing the electrode-to-electrode gap dependence of the output DC voltage of the rectifier circuit in the power receiving device for each of the conventional configuration shown in FIG. 4 and the configuration of the embodiment shown in FIG. 7. In this example, the voltage to be output to the DC-DC converter in the configuration where the power receiving device includes a DC-DC converter in a subsequent stage of the rectifier circuit was calculated. The DC-DC converter was controlled so as to output a constant electric power of 2 kW. Conditions for driving FIG. 11C are similar to FIGS. 11A and 11B.

As shown in FIG. 11C, with the circuit configuration of the present embodiment, as compared with the conventional configuration, it is possible to suppress the change in the voltage input to the DC-DC converter even when the electrode-to-electrode gap changes during a control of outputting a constant electric power, for example. Since the operation voltage range of the DC-DC converter can be designed to be narrow, the internal operation frequency range is also limited. As a result, it is easy to take measures against noise that are to foe necessary dependent on the frequency. Since it is possible to optimize the characteristics of the DC-DC converter for the narrow operation range, one can expect to increase the efficiency and reduce the heat generation of the DC-DC converter. With the configuration of the present embodiment, even if the electrode-to-electrode gap fluctuates, it is possible to operate the DC-DC converter with a voltage and a current that are substantially constant. Therefore, the conditions for suppressing the leakage electromagnetic field do not substantially change, and it is possible to reduce the research man-hour for reducing the electromagnetic noise.

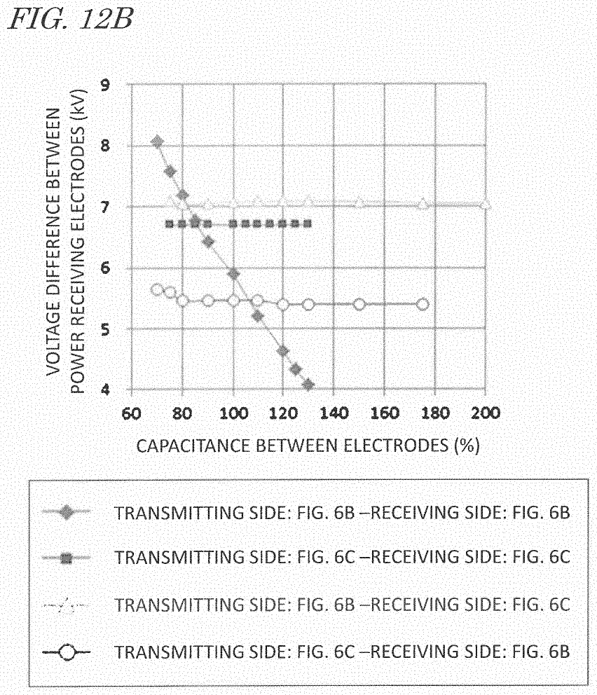

FIG. 12A is a graph showing the results of calculating the change in the voltage difference between the power transmitting electrodes when the capacitance between the power transmitting electrode and the power receiving electrode changes for four different combinations of matching circuits. FIG. 12B is a graph showing the results of calculating the change in the voltage difference between the power receiving electrodes when the capacitance between the power transmitting electrode and the power receiving electrode changes for four different combinations of matching circuits. The four combinations of matching circuits are as follows.

(1) power transmitting side: configuration in which high-pass filter and common mode choke resonator shown in FIG. 6B are connected in series, power receiving side: configuration in which high-pass filter and common mode choke resonator shown in FIG. 6B are connected in series

(2) power transmitting side: configuration in which low-pass filter and common mode choke resonator shown in FIG. 6C are connected in series, power receiving side: configuration in which low-pass filter and common mode choke resonator shown in FIG. 6C are connected in series

(3) power transmitting side: configuration in which high-pass filter and common mode choke resonator shown in FIG. 6B are connected in series, power receiving side: configuration in which low-pass filter and common mode choke resonator shown in FIG. 6B are connected in series

(4) power transmitting side: configuration in which low-pass filter and common mode choke resonator shown in FIG. 6C are connected in series, power receiving side: configuration in which high-pass filter and common mode choke resonator shown in FIG. 6B are connected in series

Herein, the capacitance between the power transmitting electrode and the power receiving electrode is an index that is in inverse proportion to the electrode-to-electrode gap discussed in conjunction with FIGS. 11A to 11C. Considering the scene of application where the wireless power transmission system of the present embodiment is used, the capacitance between electrodes can easily change. This value may change easily for reasons such as, for example, occurrence of misalignment between the transmitting and receiving electrodes including charging while moving, a change in vehicle height due to a change in load weight when charging while loading and unloading, a change in the opposing distance between the transmitting and receiving electrodes dependent on the location due to warping of the installed floor surface, etc., and a change in the opposing distance between the transmitting and receiving electrodes due to wear of a wheel member over time. The value on the horizontal axis of FIG. 12A and FIG. 12B is normalized with 83 pF capacitance being 200%. The calculation conditions are similar to the example of FIG. 11. That is, conditions used include a frequency of 485 kHz, an input DC voltage of 200 V and an output electric power of 2 kW.

From the results shown in FIG. 12A, it can be seen that with a circuit configuration where the power transmitting device has a configuration in which the high-pass filter and the common mode choke resonator are connected in series as shown in FIG. 6B and the power receiving device has a configuration in which the low-pass filter and the common mode choke resonator are connected in series as shown in FIG. 6C, the voltage difference between the power transmitting electrodes exhibits a high stability against the fluctuation of the electrode-to-electrode capacitance. It can also be seen that even with a circuit configuration where the power transmitting device has a configuration in which the high-pass filter and the common mode choke resonator are connected in series as shown in FIG. 6B and the power receiving device also has a configuration in which the high-pass filter and the common mode choke resonator are connected in series as shown in FIG. 6B, the voltage difference between the power transmitting electrodes exhibits a high stability against the fluctuation of the electrode-to-electrode capacitance. Although not shown in FIG. 12A, similar results are obtained also when a configuration obtained by substituting the configuration shown in FIG. 6B with the configuration shown in FIG. 6A or a configuration where the configuration shown in FIG. 6C is substituted with FIG. 6D is used.

From the results shown in FIG. 12B, it can be seen that with a circuit configuration where the power transmitting device has a configuration in which the high-pass filter and the common mode choke resonator are connected in series as shown in FIG. 6B, and the power receiving device has a configuration in which the low-pass filter and the common mode choke resonator are connected in series as shown in FIG. 6C, the voltage difference between the power receiving electrodes exhibits a high stability against the fluctuation of the electrode-to-electrode capacitance. Also with a circuit configuration where the power transmitting device has a configuration in which the low-pass filter and the common mode choke resonator are connected in series as shown in FIG. 6C and the power receiving device also has a configuration in which the low-pass filter and the common mode choke resonator are connected in series as shown in FIG. 6C, the voltage difference between the power receiving electrodes exhibits a high stability against the fluctuation of the electrode-to-electrode capacitance. Also with a circuit configuration where the power transmitting device has a configuration in which the low-pass filter and the common mode choke resonator are connected in series as shown in FIG. 6C and the power receiving device has a configuration in which the high-pass filter and the common mode choke resonator are connected in series as shown in FIG. 6B, the voltage difference between the power transmitting electrodes exhibits a high stability against the fluctuation of the electrode-to-electrode capacitance. Although not shown in FIG. 12B, similar results are obtained also when a configuration obtained by substituting the configuration shown in FIG. 6B with the configuration shown in FIG. 6A or a configuration where the configuration shown in FIG. 6C is substituted with FIG. 6D is used.

Summarizing the results shown in FIG. 12A and FIG. 12B, with a circuit configuration where the power transmitting device has a configuration in which the high-pass filter and the common mode choke resonator are connected in series and the power receiving device has a configuration in which the low-pass filter and the common mode choke resonator are connected in series, the voltage difference between the power transmitting electrodes and the voltage difference between the power receiving electrodes both exhibit a high stability against the fluctuation of the electrode-to-electrode capacitance.

Next, variations of the present embodiment will be described.

The matching circuits 180 and 280 are not limited to the configuration shown in FIG. 7, but many variations thereof are possible. Each of the matching circuits 180 and 280 may employ any of the various configurations as shown in FIG. 6A to FIG. 6D, for example. Among others, a configuration where the matching circuit 180 of the power transmitting device includes a high-pass filter circuit as shown in FIG. 6A or FIG. 6B and the matching circuit 280 of the power receiving device includes a low-pass filter circuit as shown in FIG. 6C or FIG. 6D has a high stability in the electrode-to-electrode voltage difference against the fluctuation of the electrode-to-electrode capacitance.

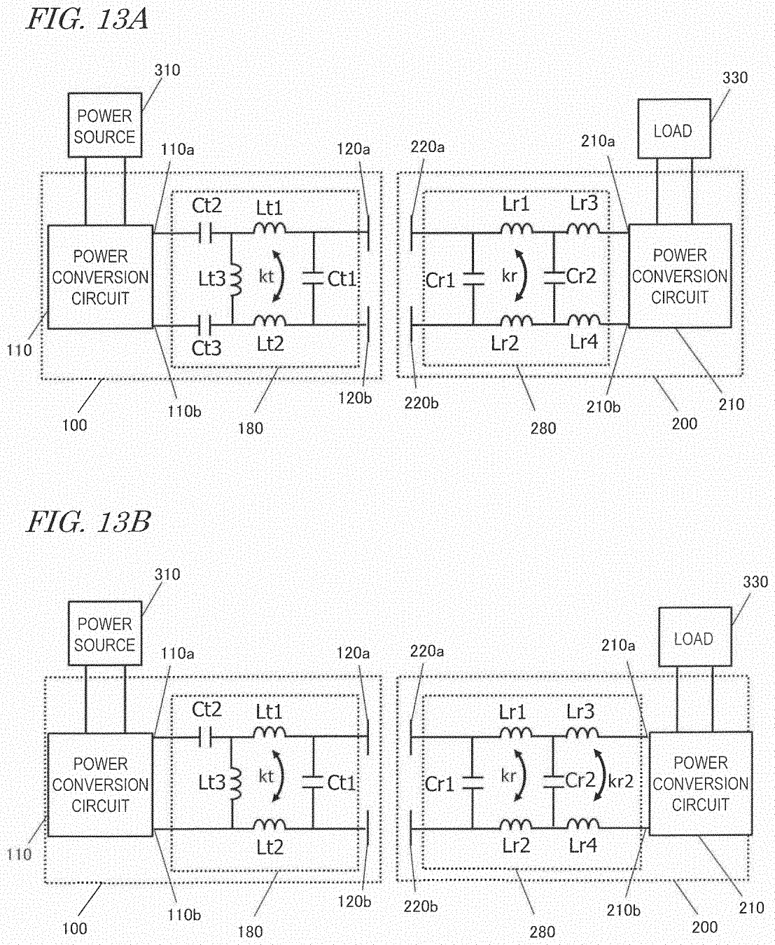

FIG. 13A shows an example where the matching circuit 180 has a configuration shown in FIG. 6A and the matching circuit 280 has a configuration shown in FIG. 6D. FIG. 13B shows an example where the matching circuit 180 has a configuration shown in FIG. 6B and the matching circuit 280 has a configuration similar to FIG. 6D. FIG. 13C shows an example where the matching circuit 180 has the configuration shown in FIG. 6B and the matching circuit 280 has the configuration shown in FIG. 6C. With either configuration, it is possible to realize advantageous effects described above.

FIG. 13D shows an example where the matching circuits 180 and 280 each have a configuration of a resonant circuit pair shown in FIG. 4 in addition to the configuration shown in FIG. 13A. The matching circuit 180 on the power transmitting side includes the series resonance circuit 130s and the parallel resonance circuit 140p between the power conversion circuit 110 and the high-pass filter circuit. The matching circuit 280 on the power receiving side includes the series resonance circuit 230s and the parallel resonance circuit 240p between the power conversion circuit 210 and the low-pass filter circuit. By using transformers as described above, it becomes easy to increase the step-up ratio of the matching circuit 180 and the step-down ratio of the matching circuit 280.

The matching circuits 180 and 280 of the embodiments described above may include, in addition to the circuit elements shown in the figures, other circuit elements, e.g., a circuit network that serves a filter function, etc. In the figures, each element that is represented as one inductor or one capacitor may be a collection of a plurality of inductors or a plurality of capacitors. For example, as shown in FIG. 14A to FIG. 14D, the configuration may be a configuration in which an inductor is divided into two inductors having inductances that are equivalent to each other and a capacitor is divided into two capacitors having capacitances that are equivalent to each other, and the points of division are connected to each other. Then, it is possible to reduce radiation noise.

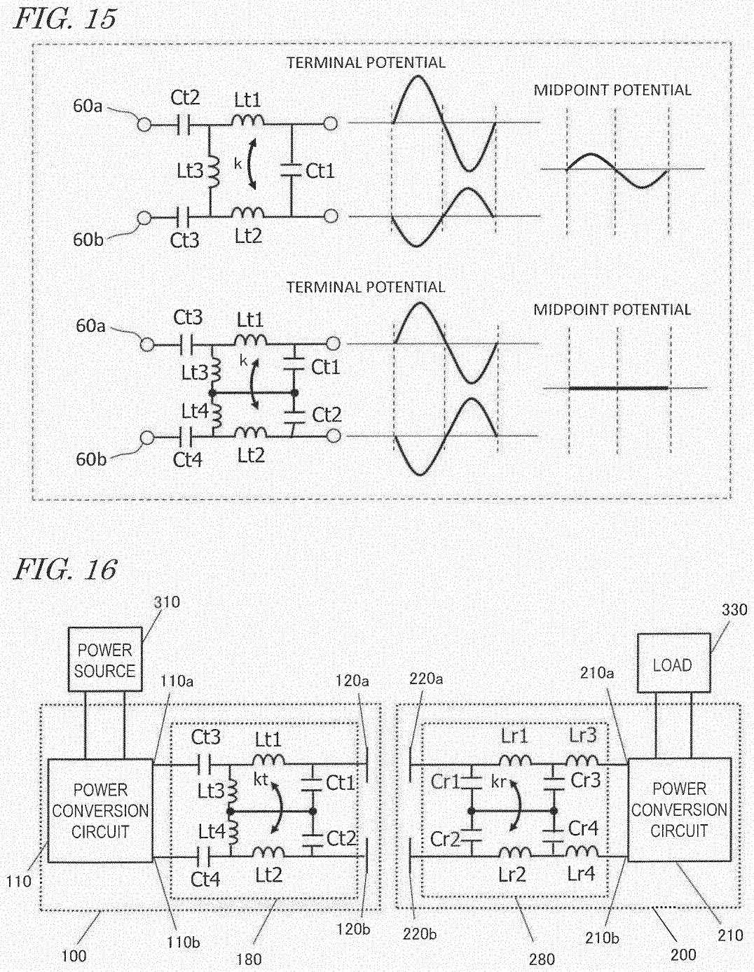

FIG. 16 shows an example of such a configuration. In this example, the matching circuit 180 in the power transmitting device 100 has a configuration shown in FIG. 14A, and the matching circuit 280 in the power receiving device 200 has a configuration shown in FIG. 14D. The matching circuit 180 may have a configuration other than that of FIG. 14A, and the matching circuit 280 may have a configuration other than that of FIG. 14D.

The electrodes of the embodiment described above have a structure where they extend parallel to each other in the same direction, but the structure does not need to be such a structure depending on the application. For example, the electrodes may have a rectangular shape such as a square shape. The technique of the present disclosure can be applied to any embodiment in which a plurality of electrodes having such a rectangular shape are arranged in one direction. Moreover, it is not an essential requirement that the surfaces of all the electrodes are on the same plane. Moreover, the surfaces of the electrodes do not need to have a completely planar shape, but may have a curved surface or a shape with protrusions/depressions, for example. Such a surface is also referred to as a “planar surface” as long as it is generally planar. The electrodes may be inclined with respect to the road surface.

The wireless power transmission system according to an embodiment of the present disclosure may be used as a system for transporting articles inside a factory, as described above. The mobile object 10 functions as a platform track that has a platform where articles are placed and autonomously moves around inside the factory to carry the articles to intended locations. However, the wireless power transmission system and the mobile object of the present disclosure are not limited to such an application, but may be used in various other applications. For example, the mobile object is not limited to an AGV, but may be another industrial machine, a service robot, an electric car, a forklift, a multicopter (drone), an elevator, or the like. For example, the wireless power transmission system can be used not only in a factory, but also in a shop, in a hospital, in a house, on a road, on a runway, and in any other place.

### INDUSTRIAL APPLICABILITY

The technique of the present disclosure can be used for any device that is driven by electric power. For example, it can be used for a mobile object such as an electric car (EV), an automated guided vehicle (AGV) used in a factory, a forklift, an unmanned aircraft (UAV), or an elevator.

### REFERENCE SIGNS LIST

10 Mobile object

20a, 20b Electrode

30 Floor surface

40a, 40b Wire

50 Electrode unit

60 Power conversion circuit

60a, 60b Terminal

30 Matching circuit

100 Power transmitting device

110 Power conversion circuit

120 Power transmitting electrode

130 First parallel resonance circuit

130s Power transmitting-side series resonance circuit

140 Second parallel resonance circuit

140p Power transmitting-side parallel resonance circuit

200 Power receiving device

210 Power conversion circuit

220 Power receiving electrode

230 Third parallel resonance circuit

230p Power receiving-side parallel resonance circuit

240 Fourth parallel resonance circuit

240s Power receiving-side series resonance circuit

280 Matching circuit

310 Power source

330 Load

1. A power transmitting module used in a power transmitting device in a wireless power transmission system of an electric field coupling method, the power transmitting module comprising:
a first electrode and a second electrode, which are a power transmitting electrode pair; and
a matching circuit to be connected between a power conversion circuit and the first and second electrodes in the power transmitting device, wherein:
the power conversion circuit includes a first terminal and a second terminal, and converts electric power output from a power source into AC power for transmission and outputs the converted power from the first and second terminals;
the matching circuit includes:
a first inductor connected to the first electrode;
a second inductor connected to the second electrode;
a first capacitor connected between a wire between the first electrode and the first inductor and a wire between the second electrode and the second inductor;
a second capacitor connected to the first inductor; and
a third inductor connected between a wire between the first inductor and the second capacitor and a wire connected to the second inductor;
on an opposite side from the first electrode, the second capacitor is to be directly or indirectly connected to the first terminal of the power conversion circuit; and
on an opposite side from the second electrode, the second inductor is to be directly or indirectly connected to the second terminal of the power conversion circuit.

2. The power transmitting module according to claim 1, wherein:
the third inductor is divided into two inductors having substantially the same inductance;
the first capacitor is divided into two capacitors having substantially the same capacitance; and
a point of division between the two inductors and a point of division between the two capacitors are directly or indirectly connected to each other.

3. The power transmitting module according to claim 1, wherein:
the matching circuit further includes a third capacitor connected to the second inductor;
the third inductor is connected between a wire between the first inductor and the second capacitor and a wire between the second inductor and the third capacitor; and
on an opposite side from the second electrode, the third capacitor is to be directly or indirectly connected to the second terminal of the power conversion circuit.

4. A power transmitting module used in a power transmitting device in a wireless power transmission system of an electric field coupling method, the power transmitting module comprising:
a first electrode and a second electrode, which are a power transmitting electrode pair; and
a matching circuit to be connected between a power conversion circuit and the first and second electrodes in the power transmitting device, wherein:
the power conversion circuit includes a first terminal and a second terminal, and converts electric power output from a power source into AC power for transmission and outputs the converted power from the first and second terminals;
the matching circuit includes:
a first inductor connected to the first electrode;
a second inductor connected to the second electrode;
a first capacitor connected between a wire between the first electrode and the first inductor and a wire between the second electrode and the second inductor;
a third inductor connected to the first inductor; and
a second capacitor connected between a wire between the first inductor and the third inductor and a wire connected to the second inductor;
on an opposite side from the first electrode, the third inductor is to be directly or indirectly connected to the first terminal of the power conversion circuit; and
on an opposite side from the second electrode, the second inductor is to be directly or indirectly connected to the second terminal of the power conversion circuit.

5. The power transmitting module according to claim 4, wherein:
the first capacitor is divided into two capacitors having substantially the same capacitance;
the second capacitor is divided into two capacitors having substantially the same capacitance; and
a point of division of the first capacitor and a point of division of the second capacitor are directly or indirectly connected to each other.

6. The power transmitting module according to claim 4, wherein:
the matching circuit further includes a fourth inductor connected to the second inductor;
the second capacitor is connected between a wire between the first inductor and the third inductor and a wire between the second inductor and the fourth inductor; and
on an opposite side from the second electrode, the fourth inductor is to be directly or indirectly connected to the second terminal of the power conversion circuit.

7. The power transmitting module according to claim 1, wherein a coupling coefficient k between the first inductor and the second inductor satisfies −1<k<0.

8. The power transmitting module according to claim 1, wherein where f1 denotes a frequency of the AC power, Lt1 denotes an inductance value of the first inductor, Lt2 denotes an inductance value of the second inductor and Ct1 denotes a capacitance value of the first capacitor, the frequency f1 is set to a value within a range of 0.5 times to 1.5 times 1/(2π((Lt1+Lt2)Ct1)^{1/2}).

9. The power transmitting module according to claim 1, wherein where Lt1 denotes an inductance value of the first inductor and Lt2 denotes an inductance value of the second inductor, a difference between Lt1 and Lt2 is smaller than 0.4 times an average value of Lt1 and Lt2.

10. The power transmitting module according to claim 1, wherein when electric power is transferred, where V0 denotes an effective value of a voltage of the AC power output from the power conversion circuit or the AC power input to the power conversion circuit and V1 denotes an effective value of a voltage between the first electrode and the second electrode, 2.14<V1/V0<50 is satisfied.

11. A power receiving module used in a power receiving device in a wireless power transmission system of an electric field coupling method, the power receiving module comprising:
a first electrode and a second electrode, which are a power receiving electrode pair; and
a matching circuit to be connected between a power conversion circuit and the first and second electrodes in the power receiving device, wherein:
the power conversion circuit includes a first terminal and a second terminal, and converts AC power input to the first and second terminals into another form of electric power that is used by a load and outputs the converted power;
the matching circuit includes:
a first inductor connected to the first electrode;
a second inductor connected to the second electrode;
a first capacitor connected between a wire between the first electrode and the first inductor and a wire between the second electrode and the second inductor;
a third inductor connected to the first inductor; and
a second capacitor connected between a wire between the first inductor and the third inductor and a wire connected to the second inductor;
on an opposite side from the first electrode, the third inductor is to be directly or indirectly connected to the first terminal of the power conversion circuit; and
on an opposite side from the second electrode, the second inductor is to be directly or indirectly connected to the second terminal of the power conversion circuit.

12. The power receiving module according to claim 11, wherein:
the first capacitor is divided into two capacitors having substantially the same capacitance;
the second capacitor is divided into two capacitors having substantially the same capacitance; and
a point of division of the first capacitor and a point of division of the second capacitor are directly or indirectly connected to each other.

13. The power receiving module according to claim 11, wherein:
the matching circuit further includes a fourth inductor connected to the second inductor;
the second capacitor is connected between a wire between the first inductor and the third inductor and a wire between the second inductor and the fourth inductor; and
on an opposite side from the second electrode, the fourth inductor is to be directly or indirectly connected to the second terminal of the power conversion circuit.

14. A power receiving module used in a power receiving device in a wireless power transmission system of an electric field coupling method, the power receiving module comprising:
a first electrode and a second electrode, which are a power receiving electrode pair; and
a matching circuit to be connected between a power conversion circuit and the first and second electrodes in the power receiving device, wherein:
the power conversion circuit includes a first terminal and a second terminal, and converts AC power input to the first and second terminals into another form of electric power that is used by a load to output the converted power;
the matching circuit includes:
a first inductor connected to the first electrode;
a second inductor connected to the second electrode;
a first capacitor connected between a wire between the first electrode and the first inductor and a wire between the second electrode and the second inductor;
a second capacitor connected to the first inductor; and
a third inductor connected between a wire between the first inductor and the second capacitor and a wire connected to the second inductor;
on an opposite side from the first electrode, the second capacitor is to be directly or indirectly connected to the first terminal of the power conversion circuit; and
on an opposite side from the second electrode, the second inductor is to be directly or indirectly connected to the second terminal of the power conversion circuit.

15. The power receiving module according to claim 14, wherein:
the third inductor is divided into two inductors having substantially the same inductance;
the first capacitor is divided into two capacitors having substantially the same capacitance; and
a point of division between the two inductors and a point of division between the two capacitors are directly or indirectly connected to each other.

16. The power receiving module according to claim 14, wherein:
the matching circuit further includes a third capacitor connected to the second inductor;
the third inductor is connected between a wire between the first inductor and the second capacitor and a wire between the second inductor and the third capacitor; and
on an opposite side from the second electrode, the third capacitor is to be directly or indirectly connected to the second terminal of the power conversion circuit.

17. The power receiving module according to claim 11, wherein a coupling coefficient k between the first inductor and the second inductor satisfies −1<k<0.

18. The power receiving module according to claim 11, wherein where f1 denotes a frequency of the AC power, Lt1 denotes an inductance value of the first inductor, Lt2 denotes an inductance value of the second inductor and Ct1 denotes a capacitance value of the first capacitor, the frequency f1 is set to a value within a range of 0.5 times to 1.5 times 1/(2π((Lt1+Lt2)Ct1)^{1/2}).

19. The power receiving module according to claim 11, wherein where Lt1 denotes an inductance value of the first inductor and Lt2 denotes an inductance value of the second inductor, a difference between Lt1 and Lt2 is smaller than 0.4 times an average value of Lt1 and Lt2.

20. The power receiving module according to claim 11, wherein when electric power is transferred, where V0 denotes an effective value of a voltage of the AC power output from the power conversion circuit or the AC power input to the power conversion circuit and V1 denotes an effective value of a voltage between the first electrode and the second electrode, 2.14<V1/V0<50 is satisfied.

21. A power transmitting device comprising:
the power transmitting module according to claim 1; and
the power conversion circuit.

22. The power transmitting device according to claim 21, wherein the power conversion circuit includes:
an inverter circuit; and
a control circuit for controlling the inverter circuit,
wherein the control circuit controls the inverter circuit to output a constant electric power.

23. A power receiving device comprising:
the power receiving module according to claim 11; and
the power conversion circuit.

24. The power receiving device according to claim 23, wherein the power conversion circuit includes:
a rectifier circuit;
a DC-DC converter connected to the rectifier circuit; and
a control circuit for controlling the DC-DC converter,
wherein the control circuit controls the DC-DC converter to output a constant electric power.

25. A wireless power transmission system comprising:
the power transmitting device according to claim 21; and
the power receiving device according to claim 23.

26. The wireless power transmission system according to claim 25, wherein power is transferred between the first and second electrodes in the power transmitting device and the first and second electrodes in the power receiving device via air.
